(19) United States
(12) Patent Application Publication
(10) Pub. No.: US 2026/0129621 A1
(43) Pub. Date: May 7, 2026

(54) MULTI-TRANSPORT BLOCK SCHEDULING FOR SIDELINK UNLICENSED

(71) Applicant: QUALCOMM Incorporated, San Diego, CA (US)

(72) Inventors: Qing LI, Princeton Junction, NJ (US); Giovanni CHISCI, San Diego, CA (US); Stelios STEFANATOS, San Diego, CA (US); Chih-Hao LIU, San Diego, CA (US); Jing SUN, San Diego, CA (US); Xiaoxia ZHANG, San Diego, CA (US)

(21) Appl. No.: 19/118,182

(22) PCT Filed: Sep. 22, 2023
(86) PCT No.: PCT/US2023/074898

§ 371 Date: Apr. 3, 2025

(30) Foreign Application Priority Data
Nov. 14, 2022 (GR) 20220100939

(51) Int. Cl. H04W 72/0446; H04W 16/14; H04W 72/23; H04W 72/40

(52) U.S. Cl. CPC H04W 72/0446; H04W 16/14; H04W 72/23; H04W 72/40

(57) ABSTRACT

Various aspects of the present disclosure generally relate to wireless communication. In some aspects, a transmitter user equipment (UE) (120) may transmit sidelink information (602) associated with the transmitter UE, the sidelink information including information associated with sidelink communication of the transmitter UE in an unlicensed spectrum. The UE may receive an indication indicating (606) a set of multi-consecutive slot transmission (MCSt) parameters to be used in association with transmitting a set of MCSt transmissions for reception (608) by a receiver UE in the unlicensed spectrum.

### CROSS-REFERENCE TO RELATED APPLICATION

This patent application claims priority to Greece Patent Application No. 20220100939, filed on Nov. 14, 2022, entitled “MULTI-TRANSPORT BLOCK SCHEDULING FOR SIDELINK UNLICENSED,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for multi-transport block (multi-TB) scheduling for sidelink unlicensed.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmitter user equipment (UE). The method may include transmitting sidelink information associated with the transmitter UE, the sidelink information including information associated with sidelink communication of the transmitter UE in an unlicensed spectrum. The method may include receiving an indication indicating a set of multi-consecutive slot transmission (MCSt) parameters to be used in association with transmitting a set of MCSt transmissions for reception by a receiver UE in the unlicensed spectrum.

Some aspects described herein relate to a method of wireless communication performed by a network node. The method may include receiving sidelink information associated with a transmitter UE, the sidelink information including information associated with sidelink communication of the transmitter UE in an unlicensed spectrum. The method may include determining a set of MCSt parameters to be used by the transmitter UE in association with transmitting a set of MCSt transmissions for reception by a receiver UE in the unlicensed spectrum. The method may include transmitting an indication indicating the set of MCSt parameters for reception by the transmitter UE.

Some aspects described herein relate to a transmitter UE for wireless communication. The transmitter UE may include one or more memories and one or more processors coupled to the one or more memories. The one or more processors may be configured to transmit sidelink information associated with the transmitter UE, the sidelink information including information associated with sidelink communication of the transmitter UE in an unlicensed spectrum. The one or more processors may be configured to receive an indication indicating a set of MCSt parameters to be used in association with transmitting a set of MCSt transmissions for reception by a receiver UE in the unlicensed spectrum.

Some aspects described herein relate to a network node for wireless communication. The network node may include one or more memories and one or more processors coupled to the one or more memories. The one or more processors may be configured to receive sidelink information associated with a transmitter UE, the sidelink information including information associated with sidelink communication of the transmitter UE in an unlicensed spectrum. The one or more processors may be configured to determine a set of MCSt parameters to be used by the transmitter UE in association with transmitting a set of MCSt transmissions for reception by a receiver UE in the unlicensed spectrum. The one or more processors may be configured to transmit an indication indicating the set of MCSt parameters for reception by the transmitter UE.

Some aspects described herein relate to a non-transitory computer-readable medium that stores a set of instructions for wireless communication by a transmitter UE. The set of instructions, when executed by one or more processors of the transmitter UE, may cause the transmitter UE to transmit sidelink information associated with the transmitter UE, the sidelink information including information associated with sidelink communication of the transmitter UE in an unlicensed spectrum. The set of instructions, when executed by one or more processors of the transmitter UE, may cause the transmitter UE to receive an indication indicating a set of MCSt parameters to be used in association with transmitting a set of MCSt transmissions for reception by a receiver UE in the unlicensed spectrum.

Some aspects described herein relate to a non-transitory computer-readable medium that stores a set of instructions for wireless communication by a network node. The set of instructions, when executed by one or more processors of the network node, may cause the network node to receive sidelink information associated with a transmitter UE, the sidelink information including information associated with sidelink communication of the transmitter UE in an unlicensed spectrum. The set of instructions, when executed by one or more processors of the network node, may cause the network node to determine a set of MCSt parameters to be used by the transmitter UE in association with transmitting a set of MCSt transmissions for reception by a receiver UE in the unlicensed spectrum. The set of instructions, when executed by one or more processors of the network node, may cause the network node to transmit an indication indicating the set of MCSt parameters for reception by the transmitter UE.

Some aspects described herein relate to an apparatus for wireless communication. The apparatus may include means for transmitting sidelink information associated with the apparatus, the sidelink information including information associated with sidelink communication of the apparatus in an unlicensed spectrum. The apparatus may include means for receiving an indication indicating a set of MCSt parameters to be used in association with transmitting a set of MCSt transmissions for reception by a receiver UE in the unlicensed spectrum.

Some aspects described herein relate to an apparatus for wireless communication. The apparatus may include means for receiving sidelink information associated with a transmitter UE, the sidelink information including information associated with sidelink communication of the transmitter UE in an unlicensed spectrum. The apparatus may include means for determining a set of MCSt parameters to be used by the transmitter UE in association with transmitting a set of MCSt transmissions for reception by a receiver UE in the unlicensed spectrum. The apparatus may include means for transmitting an indication indicating the set of MCSt parameters for reception by the transmitter UE.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example associated with multi-transport block (multi-TB) scheduling in sidelink unlicensed (SL-U), in accordance with the present disclosure.

FIGS. 7A-7C are diagrams illustrating another example associated with multi-TB scheduling in SL-U, in accordance with the present disclosure.

FIG. 8 is a diagram illustrating an example associated with a dynamic grant for multi-TB scheduling in SL-U, in accordance with the present disclosure.

FIG. 9 is a diagram illustrating an example process performed, for example, by a transmitter UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

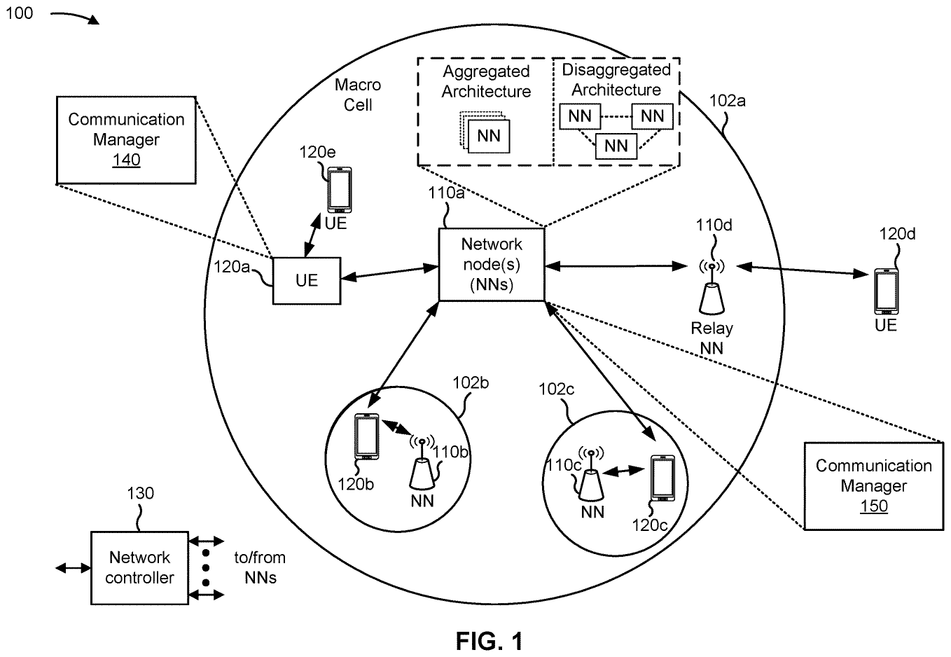

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a transmitter UE 120 may include a communication manager 140. As described in more detail elsewhere herein, the communication manager 140 may transmit sidelink information associated with the transmitter UE 120, the sidelink information including information associated with sidelink communication of the transmitter UE 120 in an unlicensed spectrum; and receive an indication indicating a set of multi-consecutive slot transmission (MCSt) parameters to be used in association with transmitting a set of MCSt transmissions for reception by a receiver UE 120 in the unlicensed spectrum. Additionally, or alternatively, the communication manager 140 may perform one or more other operations described herein.

In some aspects, the network node 110 may include a communication manager 150. As described in more detail elsewhere herein, the communication manager 150 may receive sidelink information associated with a transmitter UE 120, the sidelink information including information associated with sidelink communication of the transmitter UE 120 in an unlicensed spectrum; determine a set of MCSt parameters to be used by the transmitter UE 120 in association with transmitting a set of MCSt transmissions for reception by a receiver UE 120 in the unlicensed spectrum; and transmit an indication indicating the set of MCSt parameters for reception by the transmitter UE 120. Additionally, or alternatively, the communication manager 150 may perform one or more other operations described herein.

As indicated above, FIG. 1 is provided as an example. Other examples may differ from what is described with regard to FIG. 1.

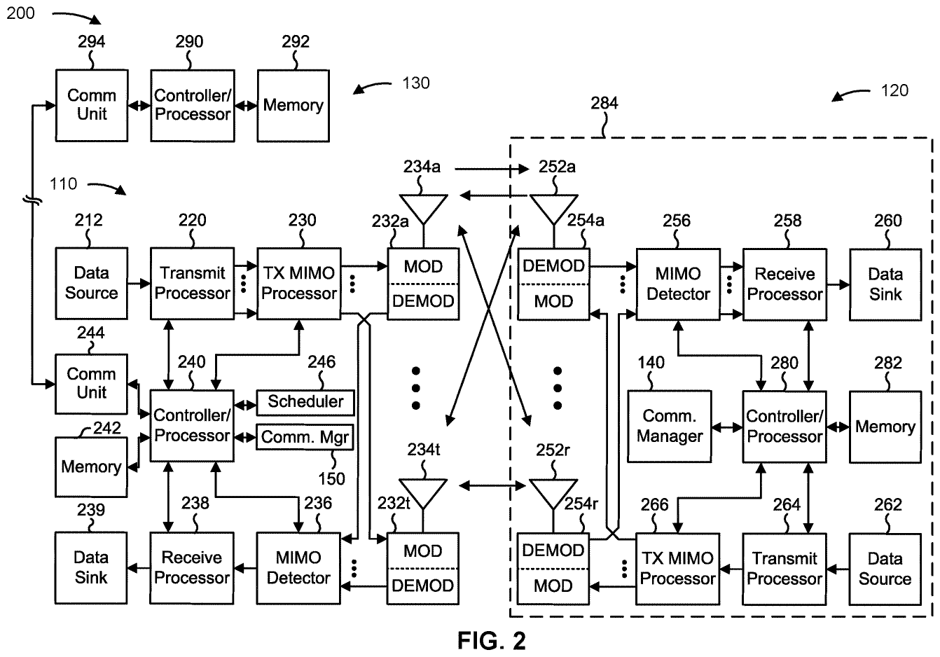

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

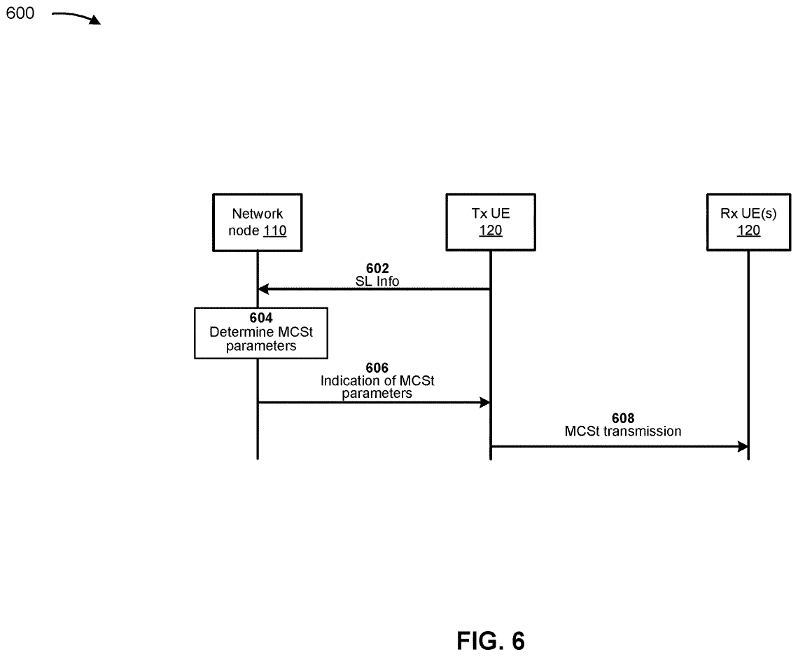

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-12).

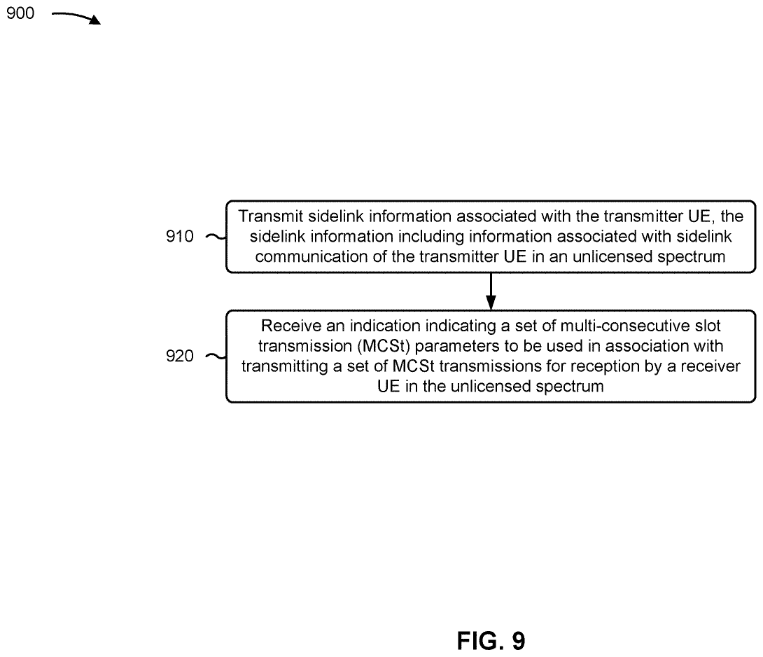

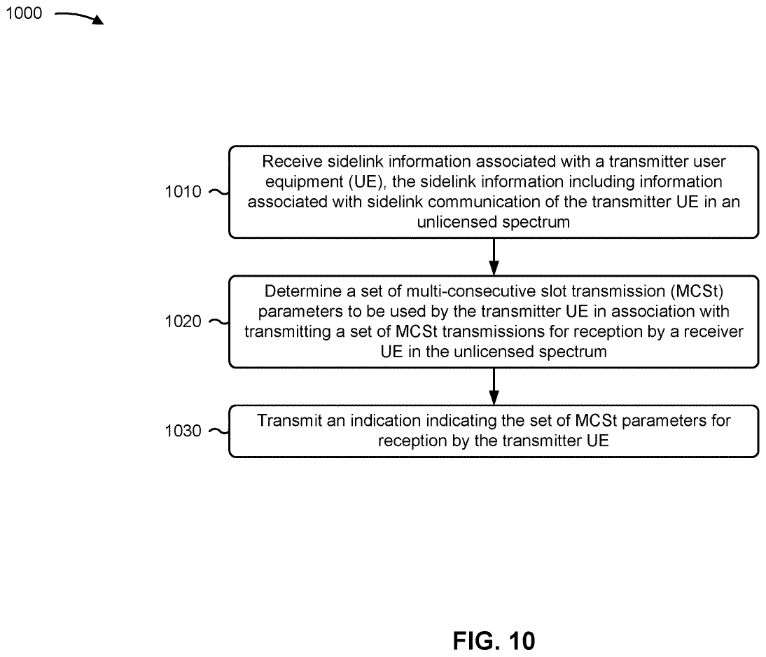

The controller/processor 240 of the network node 110, the controller/processor 280 of the UE 120, and/or any other component(s) of FIG. 2 may perform one or more techniques associated with multi-transport block (multi-TB) scheduling for sidelink unlicensed (SL-U), as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a transmitter UE 120 includes means for transmitting sidelink information associated with the transmitter UE 120, the sidelink information including information associated with sidelink communication of the transmitter UE 120 in an unlicensed spectrum; and/or means for receiving an indication indicating a set of MCSt parameters to be used in association with transmitting a set of MCSt transmissions for reception by a receiver UE 120 in the unlicensed spectrum. The means for the transmitter UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node 110 includes means for receiving sidelink information associated with a transmitter UE 120, the sidelink information including information associated with sidelink communication of the transmitter UE 120 in an unlicensed spectrum; means for determining a set of MCSt parameters to be used by the transmitter UE 120 in association with transmitting a set of MCSt transmissions for reception by a receiver UE 120 in the unlicensed spectrum; and/or means for transmitting an indication indicating the set of MCSt parameters for reception by the transmitter UE 120. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

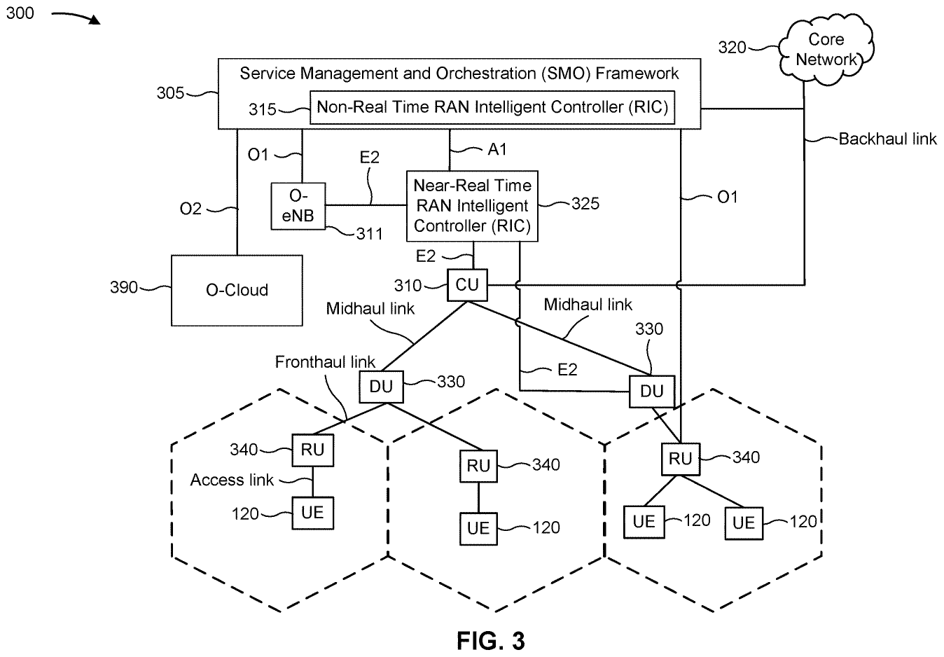

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

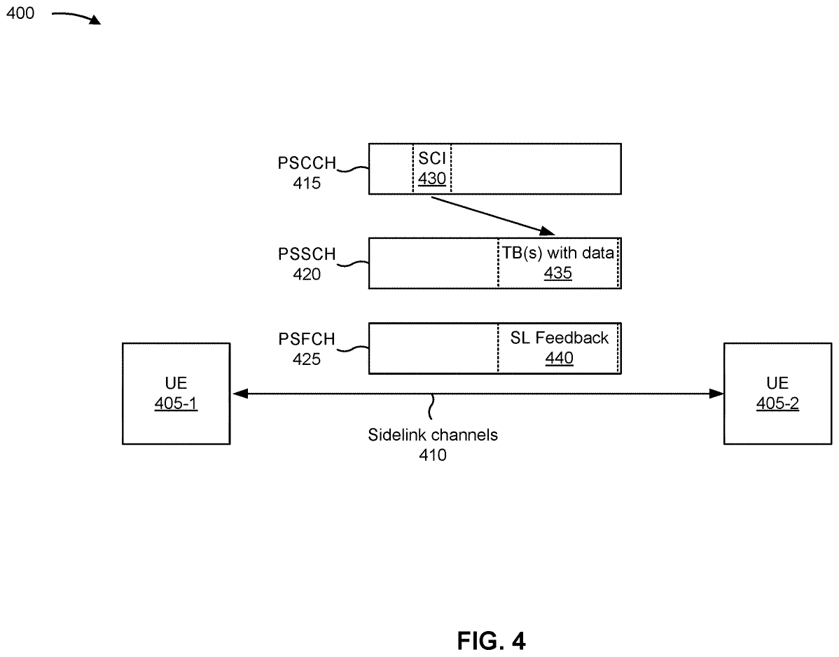

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB(s) 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink resource allocation mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a resource allocation mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP or PSCCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the resource allocation mode where resource selection and/or scheduling is performed by a UE 405 (e.g., Mode 2), the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes or slots to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

In some aspects, the techniques and apparatus for multi-TB scheduling in SL-U described herein may be applied to sidelink communications as described with respect to FIG. 4

As indicated above, FIG. 4 is provided as an example. Other examples may differ from what is described with respect to FIG. 4.

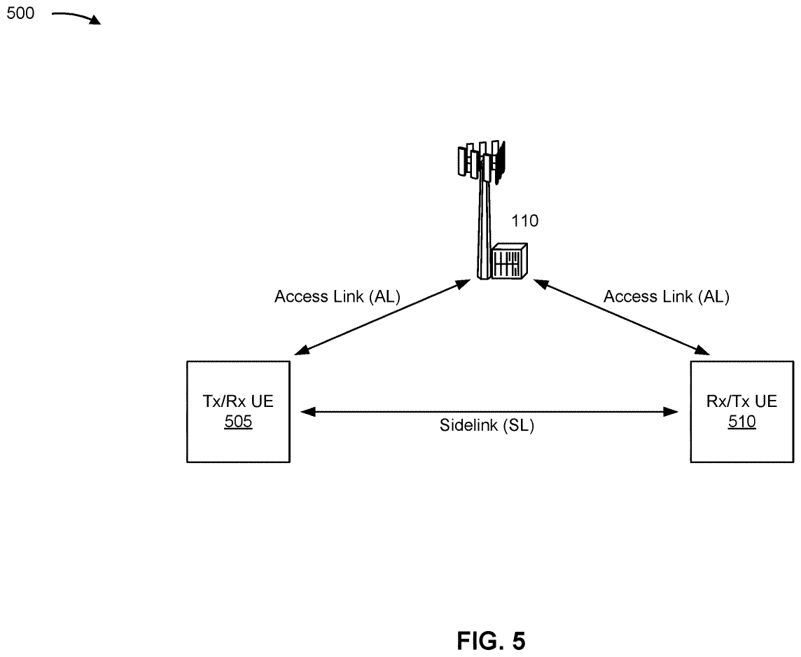

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some aspects, the techniques and apparatus for multi-TB scheduling in SL-U described herein may be applied to sidelink communications as described with respect to FIG. 5.

As indicated above, FIG. 5 is provided as an example. Other examples may differ from what is described with respect to FIG. 5.

A wireless communication system may support sidelink communication in an unlicensed spectrum (herein referred to as SL-U). For SL-U, a UE may perform channel access with a listen-before-talk (LBT) procedure on PC5 (e.g., sidelink LBT) for a sidelink communication associated with a sidelink channel access priority class (SL CAPC). When the UE obtains a sidelink channel occupancy time (SL COT) (e.g., after a successful sidelink LBT with a Type 1 channel access procedure), the UE may be configured to use the COT with continuous transmissions (as much as possible) to avoid discontinuous transmissions that may require additional sidelink LBT to be performed. In general, throughput decreases as a number of sidelink LBTs performed by the UE increases. The decreased throughput may be caused by a delayed successful LBT if the medium is busy (e.g., competition for channel access against other devices such as other UEs or WiFi devices). A sidelink LBT delay may result in an LBT failure if a UE is not able to fulfill a granted transmission, which may result in a need for a new grant to be obtained, which further reduces throughput. Furthermore, a transmission may be dropped if no successful sidelink LBT is performed within a required latency requirement (e.g., within a packet delay budget (PDB)), which may degrade reliability performance for the sidelink communication.

Some wireless communication systems may support MCSt (e.g., for resource allocation Mode 2, as described above with respect to FIG. 4) to improve QoS for a sidelink communication (e.g., to improve latency, reliability, or the like). For NR sidelink, sidelink resource scheduling via a network node (e.g., using dynamic grant with resource allocation Mode 1) is performed per-TB for a sidelink process (e.g., a sidelink HARQ process). However, sidelink resource scheduling via a network node does not currently support MCSt transmissions of multiple TBs on sidelink for SL-U. Therefore, a dynamic grant with sidelink resource allocation Mode 1 needs to be enhanced to support MCSt for SL-U.

Some techniques and apparatuses described herein enable multi-TB scheduling in SL-U. In some aspects, a transmitter UE may transmit, and a network node may receive, sidelink information associated with the transmitter UE, where the sidelink information includes information associated with sidelink communication of the transmitter UE in an unlicensed spectrum. The network node may determine, based at least in part on the sidelink information, a set of MCSt parameters to be used by the transmitter UE in association with transmitting a set of MCSt transmissions for reception by a receiver UE in the unlicensed spectrum. The network node may transmit, and the transmitter UE may receive, an indication indicating the set of MCSt parameters. The UE may transmit the set of MCSt transmissions, based at least in part on the set of MCSt parameters, for reception by the receiver UE.

In some aspects, the techniques and apparatuses described herein enable sidelink resource scheduling via the network node so as to support MCSt transmissions of multiple TBs on sidelink for SL-U, thereby providing advantages of MCSt transmission of multiple TBs (e.g., improved latency, reliability, or the like) to sidelink resource scheduling via the network node in SL-U. Additional details are provided below.

FIG. 6 is a diagram illustrating an example 600 associated with multi-TB scheduling in SL-U, in accordance with the present disclosure. As shown in FIG. 6, example 600 includes communication between a network node 110, a transmitter UE 120 (which may correspond to a UE 405 or a UE 505), and a receiver UE 120 (which may correspond to a UE 405 or a UE 505). In some aspects, the network node 110, the transmitter UE 120, and the receiver UE 120 may be included in a wireless network, such as a wireless network 100. The network node 110 may communicate with the transmitter UE 120 or the receiver UE 120 via a wireless access link, which may include an uplink and a downlink. The transmitter UE 120 and the receiver UE 120 may communicate via another wireless access link, which may include a sidelink in the unlicensed spectrum.

As shown in FIG. 6 at reference 602, the transmitter UE 120 may transmit, and the network node 110 may receive, sidelink information associated with the transmitter UE 120. In some aspects, the sidelink information includes information associated with sidelink communication of the transmitter UE 120 in an unlicensed spectrum.

In some aspects, the sidelink information includes information associated with support of the transmitter UE 120 for MCSt transmissions. The information associated with the support of the transmitter UE 120 for MCSt transmissions may include, for example, an indication that the transmitter UE 120 supports MCSt transmissions (e.g., a flag set to a value indicating that the transmitter UE 120 supports MCSt transmissions), an indication of a maximum number of TBs supported by the transmitter UE 120 in association with MCSt transmissions, or an indication of a number of consecutive slots for one or more TBs supported by the transmitter UE 120 in association with MCSt transmissions, among other examples

Additionally, or alternatively, the sidelink information may include information associated with a performance of the transmitter UE 120 with respect to operation on sidelink (e.g., PC5 interface) in the unlicensed spectrum. The information associated with the performance of the transmitter UE 120 with respect to operation in the unlicensed spectrum may include, for example, an indication of a sidelink LBT (SL LBT) success rate with respect to operation in the unlicensed spectrum, an indication of an SL LBT failure rate with respect to operation in the unlicensed spectrum, or an indication of a quantity of SL LBT failures or sidelink persistent LBT failures with respect to operation in the unlicensed spectrum, among other examples. In some aspects, the indication of the SL LBT success rate, the indication of the SL LBT failure rate, or the indication of the quantity of SL LBT failures or sidelink persistent LBT failures may be indicated per one or multiple RB sets (e.g., as preconfigured, configured or activated).

Additionally, or alternatively, the sidelink information may include an indication of a preferred value for an MCSt parameter. That is, in some aspects, the sidelink information transmitted by the transmitter UE 120 can include an indication of one or more preferred values for one or more MCSt parameters (e.g., the number of TBs, the slot number of the resource set, the number of LBT occasions, the number of RB sets, the number of subchannels of an RB set, or the like). For example, the sidelink information transmitted by the transmitter UE 120 can include a sidelink UE assistant information message with an indication of one or more preferred values for one or more MCSt parameters. For another example, the sidelink information transmitted by the transmitter UE 120 can include a sidelink buffer status report (SL BSR) message with an indication of one or more preferred values for one or more MCSt parameters. In some aspects, the transmitter UE 120 may determine the one or more preferred values for the one or more MCSt parameters based at least in part on one or more items of information, such as a QoS (e.g., one or more QoS flows or QoS profiles) associated with the sidelink communication between the transmitter UE 120 and the receiver UE 120, a channel condition (e.g., based on RSSI, RSRP, RSRQ, CQI or CBR measurements on the sidelink) associated with the sidelink between the transmitter UE 120 and the receiver UE 120, or an LBT performance characteristic associated with the transmitter UE 120 (e.g., an SL LBT success rate, an SL LBT failure rate, a quantity of SL LBT failures, or sidelink persistent LBT failures, or the like).

In some aspects, the sidelink information includes information associated with support of the receiver UE 120 for MCSt transmissions. For example, the receiver UE 120 may transmit, and the transmitter UE 120 may receive, information associated with support of the receiver UE 120 for MCSt transmissions (e.g., an indication that the receiver UE 120 supports MCSt transmissions, an indication of a maximum number of TBs, the consecutive slot number of the resource set, the number of LBT occasions, the number of RB sets, the number of subchannels of an RB set, or the like, supported by the receiver UE 120 in association with MCSt transmissions, or the like). In some aspects, the transmitter UE 120 may transmit (e.g., include or forward) the information associated with support of the receiver UE 120 for MCSt transmissions to the network node 110.

In this way, the transmitter UE 120 may transmit, and the network node 110 may receive, sidelink information that can be utilized by the network node 110 to determine a set of MCSt parameters to be used by the transmitter UE 120 for sidelink communication with the receiver UE 120.

As shown at reference 604, the network node 110 may determine a set of MCSt parameters to be used by the transmitter UE 120 in association with transmitting a set of MCSt transmissions for reception by the receiver UE 120 on sidelink in the unlicensed spectrum. In some aspects, the network node 110 determines the set of MCSt parameters based at least in part on the sidelink information associated with the transmitter UE 120. That is, in some aspects, the set of MCSt parameters is based at least in part on the sidelink information received from the transmitter UE 120.

The set of MCSt parameters includes one or more parameters based at least in part on the transmitter UE 120 is to transmit and the receiver UE 120 is to receive one or more MCSt transmissions. For example, the set of MCSt parameters may include a parameter indicating of a quantity of slots in a set of slots associated with transmitting a set of TBs. The quantity of slots in the set of slots is herein referred to as N1. As another example, the set of MCSt parameters may include a parameter indicating a quantity of TBs in the set of TBs. The quantity of TBs in the set of TBs is herein referred to as N2. As another example, the set of MCSt parameters may include a parameter indicating a subchannel allocation associated with transmitting MCSt transmissions.

In some aspects, the set of MCSt parameter includes a parameter indicating a first set of consecutive slots for initial transmissions of the set of TBs. In some aspects, the first set of consecutive slots is indicated by a first slot in the set of slots, with the first slot being indicated by a time gap associated with the first slot and a lowest index of a subchannel allocation associated with the first set of consecutive slots. That is, in some aspects, the set of MCSt parameters may include a parameter indicating the first slot of the set of N1 slots for initial transmissions for the set of N2 TBs, where the first slot is indicated by a time gap (e.g., from DCI to the first slot) and lowest index of the subchannel allocation for the set of N1 slots.

Additionally, or alternatively, the set of MCSt parameters may include a parameter indicating a second set of consecutive slots for first retransmissions associated with the set of TBs. That is, in some aspects, the set of MCSt parameters may include a parameter indicating a first reserved resource in time and frequency for the first slot of a set of N1 slots for first retransmissions for the set of N2 TBs. Similarly, in some aspects, the set of MCSt parameters may include a parameter indicating a third set of consecutive slots for second retransmissions associated with the set of TBs. That is, in some aspects, the set of MCSt parameters may include a parameter indicating a second reserved resource in time and frequency for the first slot of a set of N1 slots for second retransmissions for the set of N2 TBs.

In some aspects, the set of MCSt parameters includes a parameter indicating a set resources associated with acknowledgment of MCSt transmissions. For example, the set of MCSt parameters may include a parameter indicating a set of resources in which the transmitter UE 120 may indicating an acknowledgment (e.g., a 1-bit ACK) associated with the initial transmissions of the set of TBs. As another example, the set of MCSt parameters may include a parameter indicating a set of resources in which the transmitter UE 120 may indicating an acknowledgment (e.g., a 1-bit ACK) associated with the first retransmissions of the set of TBs. In some aspects, a set of resources associated with acknowledgment of the MCSt transmissions (e.g., initial transmissions or first retransmissions) can be utilized by the transmitter UE 120 to transmit, to the network node 110, an ACK indicating that the receiver UE 120 successfully received each TB in the set of TBs. The network node 110 can release reserved resources associated with the MCSt transmissions for use for other communications, thereby increasing network efficiency and reducing resource waste. For example, if the transmitter UE 120 receives sidelink feedback indicating that the receiver UE 120 has successfully received the initial transmission of each TB in the set of TBs, then the transmitter UE 120 may transmit a 1-bit ACK to the network node 110 in the indicated set of resources, and the network node 110 can release resources reserved for first retransmissions for the set of TBs and second retransmissions for the set of TBs. As another example, if the transmitter UE 120 receives sidelink feedback indicating that the receiver UE 120 has successfully received each TB in the set of TBs after the first retransmissions, then the transmitter UE 120 may transmit a 1-bit ACK to the network node 110 in the indicated set of resources, and the network node 110 can release resources reserved for second retransmissions for the set of TBs. In some aspects, the set of MCSt parameters includes a parameter indicating a set of resources to be used associated with transmitting acknowledgment information (e.g., ACK/NACK) associated with the set of TBs (e.g., based on the ACK/NACK received from the receiver UE 120 for each TB in the set of TBs after the second retransmissions) or acknowledgment information (e.g., ACK/NACK) associated with the set of consecutive slots for initial transmissions and or retransmissions of the set of TBs.

In some aspects, the set of resources associated with transmitting the acknowledgment information comprises a set of PUCCH resources. Additionally, or alternatively, the set of resources associated with transmitting the acknowledgment information may comprise a set of PUSCH resources, such as carrying a set of uplink control information (UCI) in a PUSCH. In some aspects, the set of UCIs may be used to indicate, for example, a quantity of TBs that need to be retransmitted by the transmitter UE 120 or a quantity of NACKs received from the receiver UE 120. In this way, the set of resources associated with transmitting the acknowledgment information can be utilized by the transmitter UE 120 to indicate to the network node 110 an amount of resources needed for a second grant on sidelink associated with the TBs to be retransmitted.

In some aspects, the set of MCSt parameters includes a HARQ process number associated with one or more TBs of the set of TBs. For example, the set of MCSt parameters may, in some aspects, include a parameter indicating a HARQ process number for the set of N2 TBs in a first grant (e.g., a first DCI grant) with an NDI toggled (e.g., for an initial transmission of N2 TBs). As another example, the set of MCSt parameters may include a parameter indicating a HARQ process number for a subset of TBs from the set of N2 TBs in a second grant (e.g., a second DCI grant) with NDI not toggled (e.g., for retransmissions of subset of TBs from the set of N2 TBs). Notably, this HARQ process number can be associated with one or more TBs (e.g., per a grant on sidelink) rather being associated with a single TB (e.g., per a TB transmission).

In some aspects, the set of MCSt parameters includes a parameter indicating a subchannel allocation configuration for the set of TBs. For example, the set of MCSt parameters may include a parameter indicating a code point, an index, or an identifier of a subchannel allocation configuration, configured on the UE 120, that is to be used for the set for N2 TBs. In some aspects, the set of MCSt parameters may include one or more RB sets. For example, the subchannel allocation configuration may be associated to one or more RB sets.

In some aspects, the set of MCSt parameters may be associated to granularity of sidelink LBT, for example, one or more RB sets or one or more resource pools (e.g., different N1 and/or N2 values or subchannel allocations for different RB sets or resource pools, different ACK/NACK resources on PUCCH or PUSCH for different RB sets or resource pools, or the like).

As shown at reference 606, the network node 110 may transmit, and the UE 120 may receive an indication indicating the set of MCSt parameters to be used by the transmitter UE 120 in association with transmitting a set of MCSt transmissions for reception by the receiver UE 120 in the unlicensed spectrum.

In some aspects, the indication includes a sidelink unlicensed configuration that is communicated via RRC signaling, where the sidelink unlicensed configuration includes an MCSt configuration indicating the set of MCSt parameters. That is, in some aspects, the indication of the MCSt parameters is transmitted by the network node 110 and received by the transmitter UE 120 via an RRC configuration including an MCSt configuration indicating one or more MCSt parameters. In some aspects, the transmitter UE 120 may transmit the received sidelink unlicensed configuration including an MCSt configuration indicating one or more MCSt parameters for reception by the receiver UE 120 via RRC signaling on sidelink (e.g., a PC5 RRC configuration message). That is, in some aspects, the transmitter UE 120 may forward the sidelink unlicensed configuration to the receiver UE 120 on sidelink.

Additionally, or alternatively, the indication may include a reconfiguration message communicated via RRC signaling, where the reconfiguration message includes information associated with reconfiguring the set of MCSt parameters. That is, in some aspects, the indication of the MCSt parameters is transmitted by the network node 110 and received by the transmitter UE 120 in an RRC reconfiguration message associated with reconfiguring a set of MCSt parameters configured on the transmitter UE 120. In some aspects, the transmitter UE 120 may transmit the received reconfiguration message for reception by the receiver UE 120 via RRC signaling on sidelink (e.g., a PC5 RRC configuration message).

Additionally, or alternatively, the indication may include an activation message communicated via a MAC control element (CE), where the activation message includes information associated with activating the set of MCSt parameters. That is, in some aspects, the indication of the MCSt parameters is activated or deactivated by the network node 110 and received by the transmitter UE 120 in a MAC CE associated with activating or deactivating a set of MCSt parameters configured on the transmitter UE 120. In some aspects, the transmitter UE 120 may transmit the activation or deactivation message for reception by the receiver UE 120 via a MAC CE on sidelink (e.g., PC5 MAC CE).

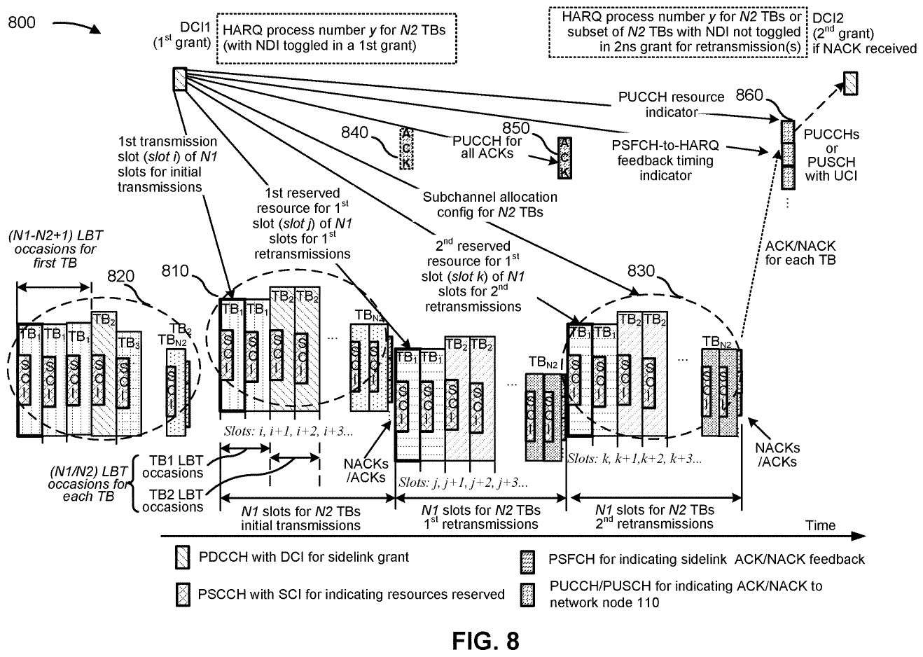

Additionally, or alternatively, the indication may include a dynamic grant communicated in DCI, where the dynamic grant indicates the set of MCSt parameters. An example associated with a dynamic grant communicated in DCI is described below with respect to FIG. 8. In some aspects, the dynamic grant is associated with one or more RB sets. In some aspects, the network node 110 may select the one or more RB sets based at least in part on the sidelink information associated with the transmitter UE 120. For example, in some aspects, the network node 110 may select the one or more RB sets based at least in part on per-RB set or per multi-RB set LBT performance information (e.g., an SL LBT success rate, an SL LBT failure rate, a quantity of SL LBT failures, or sidelink persistent LBT failures, or the like, on the one or more RB sets) provided by the transmitter UE 120 or other UEs 120 in a sidelink information message or a sidelink measurement report message. For another example, in some aspects, the network node 110 may select the one or more RB sets based at least in part on the channel condition on sidelink (e.g., RSSI, RSRP, RSRQ, CQI or CBR measurements, or the like, on the one or more RB sets) provided by the transmitter UE 120 or other UEs 120 in a sidelink information message or a sidelink measurement report message.

In some aspects, the dynamic grant is associated with one or more resource pools. In some aspects, the network node 110 may select the one or more resource pools based at least in part on the sidelink information associated with the transmitter UE 120 or other UEs 120. For example, in some aspects, the network node 110 may select the one or more resource pools based at least in part on LBT performance information provided by the transmitter UE 120 or other UEs 120 in a sidelink information message or a sidelink measurement report message. For example, in some aspects, the network node 110 may select the one or more resource pools based at least in part on the channel condition on sidelink provided by the transmitter UE 120 or other UEs 120 provided in a sidelink information message (e.g., an SL LBT success rate, an SL LBT failure rate, a quantity of SL LBT failures, or sidelink persistent LBT failures, or the like, on the one or more RB sets) or a sidelink measurement report message (e.g., RSSI, RSRP, RSRQ, CQI or CBR measurements, or the like, on the one or more RB sets).

As shown at reference 608, the transmitter UE 120 may transmit one or more MCSt transmissions on sidelink for reception by the receiver UE 120 based at least in part on the set of MCSt parameters received.

In some aspects, the transmitter UE 120 may perform an LBT procedure at one or more of LBT occasions based at least in part on the set of MCSt parameters, where the one or more LBT occasions are associated with a transmission of a TB from the set of TBs. For example, the transmitter UE 120 may perform the LBT procedure at a first LBT occasion in association with transmitting an initial transmission of a first TB from the set of TBs. Here, if the LBT procedure fails (i.e., if the transmitter UE 120 fails to obtain the channel accessing (e.g., via initiating a COT or sharing a COT)), then the UE 120 may perform the LBT procedure at a second LBT occasion in association with transmitting the initial transmission of the first TB, and so on. Upon a passing of the LBT procedure (i.e., when the transmitter UE 120 obtains the channel accessing via initiating a COT or sharing a COT at the LBT occasion), the UE 120 may transmit the initial transmission of the first TB. In some aspects, the transmitter UE 120 may continue the initial transmissions of the other one or more TBs of the set of N2 TBs without LBT (e.g., the slots for transmitting the other one or more TBs of the set of N2 TBs are adjacent to each other, for example, with the time gap equal or smaller than a threshold, which doesn't require an LBT procedure). In some aspects, the transmitter UE 120 may continue transmitting one or more other transmissions such as first retransmissions or second retransmissions of one or more TBs of the set of N2 TBs (e.g., a first retransmission of the first TB, a first retransmission of the second TB, a second retransmission of the first TB, a second retransmission of the second TB, and so on) without LBT (e.g., the slots for retransmitting the one or more TBs of the set of N2 TBs are adjacent to each other, for example, with the time gap equal or smaller than a threshold, which doesn't require an LBT procedure). In some aspects, the transmitter UE 120 may perform the LBT procedure at one or more further LBT occasions in association with transmitting one or more other transmissions (e.g., an initial transmission of a second TB, a third TB, and so on, based on the time gap, for example, equal or larger than a threshold, between the slots for transmitting the other one or more TBs of the set of N2 TBs). For example, a full scale LBT such as type 1 LBT without COT sharing or a reduced scale LBT such as type 2 LBT with COT sharing, or in a similar manner, as needed. In some aspects, the transmitter UE 120 may perform the LBT procedure at one or more further LBT occasions in association with transmitting one or more other transmissions (e.g., a first retransmission of the first TB, a first retransmission of the second TB, a second retransmission of the first TB, a second retransmission of the second TB, and so on, based on the time gap between the slots for retransmitting the other one or more TBs of the set of N2 TBs). For example, a full scale LBT such as type 1 LBT without COT sharing or a reduced scale LBT such as type 2 LBT with COT sharing, or in a similar manner, as needed.

In some aspects, the transmitter UE 120 may include a sidelink HARQ (SL HARQ) process number in a transmission of a TB of the set of TBs. For example, the transmitter UE 120 may transmit an initial transmission of a first TB from the set of TBs, with the initial transmission of the first TB including SCI indicating a first SL HARQ process number associated with the first TB. Here, the transmitter UE 120 may derive the first SL HARQ process number associated with the first TB based at least in part on the HARQ process number received in the set of MCSt parameters. Continuing with this example, the transmitter UE 120 may transmit an initial transmission of a second TB from the set of TBs, with the initial transmission of the second TB including SCI indicating a second SL HARQ process number associated with the second TB. Here, the transmitter UE 120 may derive the second SL HARQ process number associated with the second TB based at least in part on the HARQ process number received in the set of MCSt parameters. Notably, a given SL HARQ process number may be associated with a single TB from the set of TBs and derived from (e.g., is different from) the HARQ process number indicated in the set of MCSt parameters (which can be associated with multiple TBs).

In some aspects, as described above, the transmitter UE 120 may receive (e.g., ACK(s) on one or more PSFCH for the set of TBs received) sidelink feedback information indicating that all TBs in the set of TBs have been received by the receiver UE 120, and may transmit, on uplink to the network node 110, an acknowledgment (e.g., a 1-bit ACK) associated with the set of TBs. In some aspects, the acknowledgment is transmitted in a set of resources indicated by the set of MCSt parameters.

Additionally, or alternatively, as described above, the transmitter UE 120 may receive (e.g., ACK(s) and/or NACK(s) on one or more PSFCH for the set of TBs received) sidelink feedback information associated with the set of TBs. Here, the transmitter UE 120 may transmit, on uplink to the network node 110, acknowledgment information (e.g., one or more ACKs or one or more NACKs) associated with the set of TBs. In some aspects, the acknowledgment information is transmitted in a set of resources indicated by the set of MCSt parameters. For example, the transmitter UE 120 may transmit multiple ACKs/NACKs associated with multiple corresponding TBs on a PUCCH that is configured, activated, or indicated in a dynamic grant. As another example, the transmitter UE 120 may transmit ACKs/NACKs associated with multiple corresponding TBs on a PUSCH with UCI(s) (e.g., indicating a quantity of TBs to be retransmitted or a quantity of NACKs) as configured, activated, or indicated in DCI.

In some aspects, the network node 110 may determine, based at least in part on the acknowledgment information received from the transmitter UE 120, a second set of MCSt parameters to be used by the transmitter UE 120 in association with transmitting one or more retransmissions associated with the set of MCSt transmissions. In some aspects, the network node 110 may determine the second set of MCSt parameters in a manner similar to that described above. In some aspects, the network node 110 may transmit, and the transmitter UE 120 may receive, a second indication indicating the second set of MCSt parameters to be used in association with transmitting the one or more retransmissions, and may transmit the one or more retransmissions based at least in part on the second set of MCSt parameters accordingly.

As indicated above, FIG. 6 is provided as an example. Other examples may differ from what is described with respect to FIG. 6.

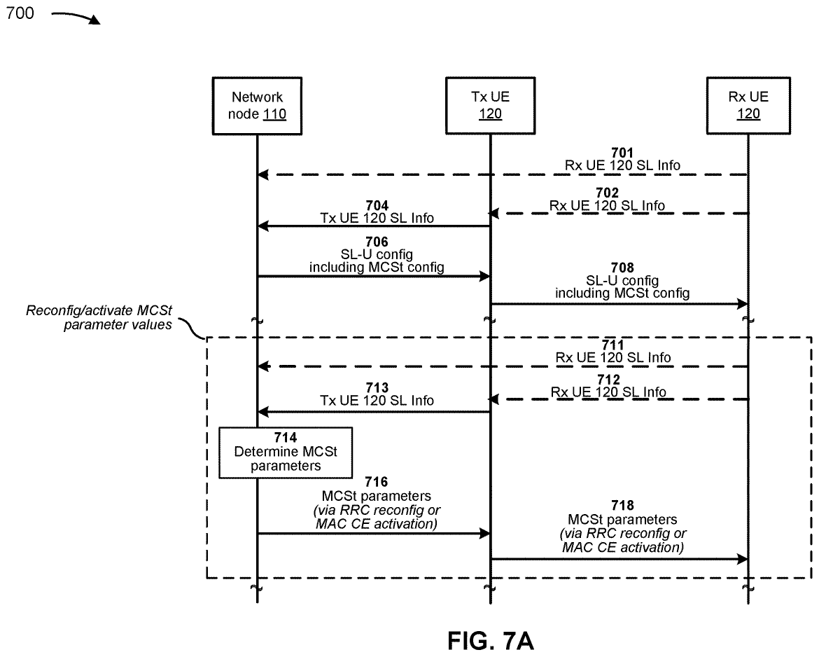

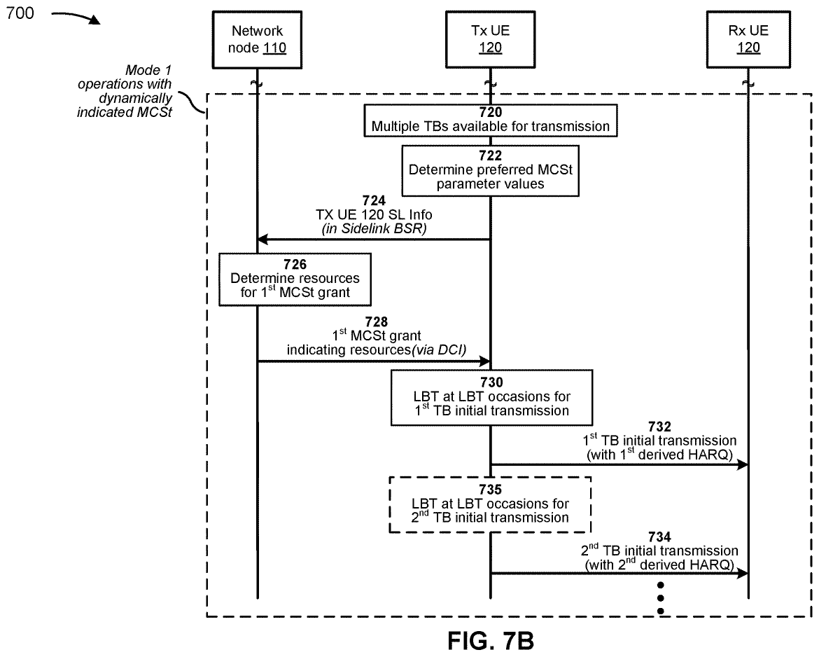

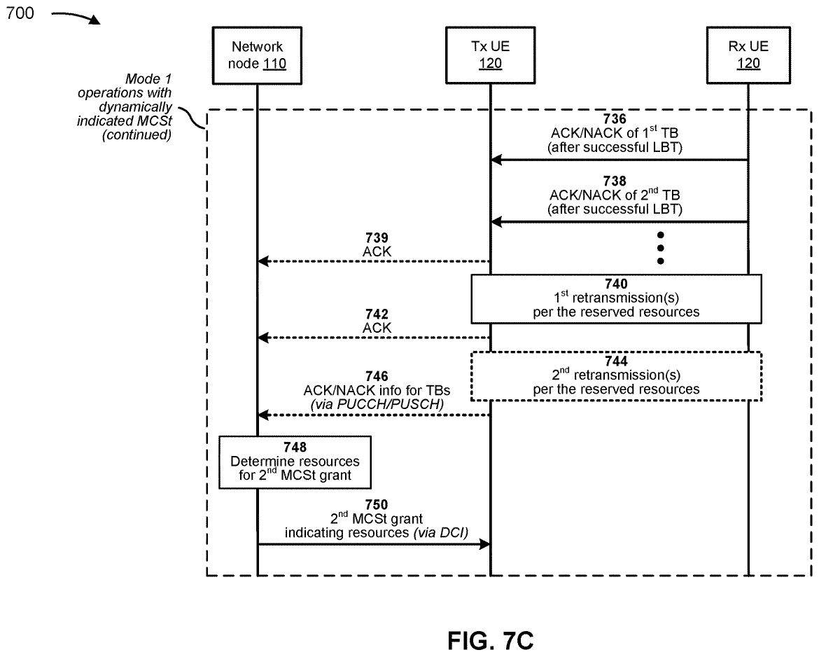

FIGS. 7A-7C are diagrams illustrating an example 700 associated with multi-TB scheduling in SL-U, in accordance with the present disclosure. As shown in FIGS. 7A-7C, example 700 includes communication between a network node 110, a transmitter UE 120 (which may correspond to a UE 405 or a UE 505), and a receiver UE 120 (which may correspond to a UE 405 or a UE 505). In some aspects, the network node 110, the transmitter UE 120, and the receiver UE 120 may be included in a wireless network, such as a wireless network 100. The network node 110 may communicate with the transmitter UE 120 or the receiver UE 120 via a wireless access link, which may include an uplink and a downlink. The transmitter UE 120 and the receiver UE 120 may communicate via another wireless access link, which may include a sidelink in the unlicensed spectrum. FIGS. 7A-7C show an example of a particular implementation of the techniques described above with respect to FIG. 6.

In some aspects, as shown in FIG. 7A at references 701 and 704, the receiver UE 120 and the transmitter UE 120, respectively, may transmit sidelink information to the network node 110. Here, the sidelink information may include information based at least in part on which the network node 110 can determine a sidelink unlicensed configuration for a sidelink communication between the transmitter UE 120 and the receiver UE 120. Such information may include, for example, an indication of support for MCSt, a maximum quantity of TBs supported for MCSt, a number of consecutive slots for MCSt, a number of RB sets or a number of subchannels of an RB set for MCSt, or the like. In some aspects, as shown in FIG. 7A, the receiver UE 120 may transmit sidelink information (e.g., sidelink UE information with the receiver UE 120's capability of MCSt, such as support for MCSt or the receiver UE 120's preferred MCSt parameters, such as a maximum quantity of TBs for MCSt, a number of consecutive slots for MCSt, a number of RB sets or a number of subchannels of a RB set for MCSt, or the like) to the transmitter UE 120 at references 702 and the transmitter UE 120 may transmit sidelink information including the received sidelink information from the receiver UE 120 to the network node 110 at references 704. Here, the sidelink information may include information based at least in part on which the network node 110 can determine a sidelink unlicensed configuration for a sidelink communication between the transmitter UE 120 and the receiver UE 120. Such information may include, for example, an indication of support for MCSt, a maximum quantity of TBs supported for MCSt, or the like.

As shown at reference 706, the network node 110 may transmit an RRC configuration for the sidelink communication, with the RRC configuration including an SL-U configuration. Here, the SL-U configuration may include an MCSt configuration indicating one or more MCSt parameters, such as one or more N1 values of consecutive slots, one or more N2 values of TBs, or one or more RB sets and/or one or more subchannel allocations of an RB set for MCSt, among other examples.

As shown at reference 708, the transmitter UE 120 may transmit the received SL-U configuration to the receiver UE 120 (e.g., via a PC5 RRC message).

In this way, an MCSt configuration indicating a set of MCSt parameters may be configured on the transmitter UE 120 (and the receiver UE 120).

As indicated in FIG. 7A, in some aspects, a set of MCSt parameters can be reconfigured or activated for the transmitter UE 120 or the receiver UE 120. For example, as shown at references 711 and 713, the receiver UE 120 and the transmitter UE 120, respectively, may transmit sidelink information (e.g., an assistance information for sidelink or sidelink report) to the network node 110. For another example, as shown in in FIG. 7A, the receiver UE 120 may transmit sidelink information (e.g., an assistance information for sidelink or sidelink report) to the transmitter UE 120 at references 712 and the transmitter UE 120 may transmit sidelink information including the received sidelink information from the receiver UE 120 to the network node 110 at references 713. In some aspects, the sidelink information may include information associated with SL-U operation performance, such as information indicating an SL LBT success rate associated with SL-U, information indicating an SL LBT failure rate associated with SL-U, or information indicating a quantity of SL LBT failures, or persistent SL LBT failure, among other examples. In some aspects, the sidelink information may include information associated with sidelink channel condition, such as information indicating sidelink measurement such as RSSI, RSRP, RSRQ, CQI, or CBR, among other examples.

As shown at reference 714, the network node 110 may determine the set of MCSt parameters (e.g., one or more values for one or more corresponding MCSt parameters) based on the sidelink information received from the transmitter UE 120 and/or the receiver UE 120 or other UEs 120 in the proximity. For example, the network node 110 may determine the RB set(s), a resource pool, or the like, based on LBT performance (e.g., persistent SL LBT failure, or the like). As another example, the network node 110 may determine the number of consecutive slots or the number of TBs based on the channel condition (e.g., RSSI, CBR, or the like.)

As shown at reference 716, the network node 110 may transmit an indication of the set of MCSt parameters via RRC signaling (e.g., to reconfigure the set of MCSt parameters on the transmitter UE 120, for example, with the SL-U configuration) or via a MAC CE or DCI (e.g., to activate or deactivate the set of MCSt parameters on the transmitter UE 120, for example, as configured with SL-U configuration at reference 706). For example, the network node 110 may reconfigure or activate the RB set(s), a resource pool, or the like, based on LBT performance (e.g., persistent SL LBT failure, or the like). As another example, the network node 110 may reconfigure or activate the number of consecutive slots, the number of TBs, or the like, based on the channel condition (e.g., RSSI, CBR, or the like.)

As shown at reference 718, the transmitter UE 120 may transmit the RRC reconfiguration or MAC CE activation or deactivation to the receiver UE 120 (e.g., via a PC5 RRC message or via MAC CE, respectively).

In this way, a set of MCSt parameters may be reconfigured or activated or deactivated on the transmitter UE 120 or the receiver UE 120.

As indicated in FIG. 7B, in some aspects, a set of MCSt parameters for the transmitter UE 120 or the receiver UE 120 can dynamically indicated for Mode 1 sidelink resource allocation. For example, as shown at reference 720, the transmitter UE 120 may have multiple TBs ready for transmission to the receiver UE 120.

As shown at reference 722, the transmitter UE 120 may determine one or more preferred values for one or more MCSt parameters. In some aspects, the transmitter UE 120 may determine the one or more preferred values based at least in part on, for example, the QoS associated with the one or more TBs (e.g., reliability, priority, latency requirement such as PDB, or the like), a channel condition (e.g., a sidelink RSSI, RSRP, RSRQ or QCI measurement, or CBR measurement), or an LBT performance metric (e,g., SL LBT success rate, SL LBT failure rate, a quantity of SL LBT failures, or persistent SL LBT failure), among other examples.

In some aspects, the transmitter UE 120 may determine the one or more MCSt parameter values based at least in part on, for example, the MCSt parameters and other sidelink configurations (e.g., configured grant resources, start offset, period, or the like, for sidelink configured grant type 1) as configured with SL-U configuration at reference 706 in FIG. 7A or as reconfigured with SL-U configuration at reference 716, and then the transmitter UE 120 may perform LBT at one or more LBT occasions in association with transmitting an initial transmission of a first TB of a set of TBs at reference 730 (e.g., skipping steps at references 724, 726, and 728), based on the determined MCSt parameter values and sidelink configured grant type 1 configuration(s) configured or reconfigured.

In some aspects, the transmitter UE 120 may determine the one or more MCSt parameter values (such as N1 value of consecutive slots, N2 value of TBs, a number of RB sets and/or a number of subchannels of an RB set, among other examples) based at least in part on, for example, the MCSt parameters and other sidelink configurations (e.g., configured grant resources for sidelink configured grant type 2 as activated with DCI at reference 716 in FIG. 7A or configured grant resources for sidelink configured grant type 1 as configured or reconfigured with RRC at reference 706 or 716 in FIG. 7A), and then the transmitter UE 120 may perform LBT at one or more LBT occasions in association with transmitting an initial transmission of a first TB of a set of TBs at reference 730 (e.g., skipping steps at references 724, 726, and 728), based on the determined MCSt parameter values and sidelink configured grant type 2 configuration(s) activated.

With a configured grant configuration (e.g., type 1 or type 2), for initially transmitting a first one or more TBs of a set of TBs, the transmitter UE 120 may determine one or more LBT occasions at one or more consecutive slots within a first configured grant occasion of the configured grant configuration (e.g., a configured grant occasion may contain one or more slots during a configured grant period) and may transmit the first one or more TBs of the set of TBs using the remaining slots of the configured grant occasion after a successful LBT. Additionally, or alternatively, the transmitter UE 120 may determine one or more LBT occasions at one or more continuous slots within a second configured grant occasion of the configured grant configuration and retransmit the first one or more TBs of the set of TBs or initially transmit a second one or more TBs of a set of TBs using the remaining slots of the configured grant occasion after a successful LBT. With the initial transmissions or retransmissions with the configured grant configuration, a HARQ ID is indicated in SCI-2 for each TB of the first and second one or more TBs of the set of TBs. With multiple configured grant configurations (e.g., type 1 or type 2), for initially transmitting a first one or more TBs of a set of TBs, the transmitter UE 120 may determine one or more LBT occasions at one or more consecutive slots within a first one or more configured grant occasions of the one or more configured grant configurations respectively and transmit the first one or more TBs of the set of TBs using the remaining slots of the one or more configured grant occasions after a successful LBT. Additionally, or alternatively, the transmitter UE 120 may determine one or more LBT occasions at one or more consecutive slots within a second one or more configured grant occasions of the one or more configured grant configurations respectively and retransmit the first one or more TBs of the set of TBs or initially transmit a second one or more TBs of a set of TBs using the remaining slots of the one or more configured grant occasions after a successful LBT. With the initial transmissions or retransmissions with the one mor more configured grant configurations, a HARQ ID is indicated in SCI-2 for each TB of the first and second one or more TBs of the set of TBs.

As shown at reference 724, the transmitter UE 120 may transmit sidelink information indicating the one or more preferred values (e.g., number of TBs, number of consecutive slots, number of LBT occasions, number of RB sets, number of subchannels of an RB set, or the like) in a sidelink BSR message that is received by the network node 110.

As shown at reference 726, the network node 110 may determine, based at least in part on the sidelink information included in the SL BSR message, a set of MCSt parameters. Here, the set of MCSt parameters may include a set of resources allocated to the transmitter UE 120 for a first MCSt grant.

As shown at reference 728, the network node 110 may transmit, and the transmitter UE 120 may receive, first DCI indicating the set of MCSt parameters (e.g., the sidelink resources (with consecutive slots in time and RB set(s) or subchannels of an RB set in frequency) associated with the first MCSt grant).

As shown at reference 730, the transmitter UE 120 may perform LBT at one or more LBT occasions over the RB set(s) in association with transmitting an initial transmission of a first TB of a set of TBs.

As shown at reference 732, upon a success the LBT procedure (e.g., when the transmitter UE 120 obtains the channel via initiating a COT or sharing a COT), the transmitter UE 120 may transmit the initial transmission of the first TB in the first slot with successful LBT. In some aspects, the initial transmission of the first TB includes a first SL HARQ process number (e.g., in the SCI-2 transmitted with the first TB), where the first SL HARQ process number is derived based on the HARQ process number indicated in the first DCI.

As shown at reference 734, the transmitter UE 120 may further transmit an initial transmission of a second TB of the set of TBs (e.g., in the slot immediately following the initial transmission of the first TB). In some aspects, the transmitter UE 120 may further transmit an initial transmission of a second TB of the set of TBs without LBT procedure if the time gap between the initial transmission of the first TB and the initial transmission of the second TB is below a threshold (for continuous transmission) (e.g., the threshold may be preconfigured or indicated from upper layer such as service layer or application layer with the sidelink unlicensed configuration for a sidelink communication QoS described at reference 701 or reference 702 in FIG. 7A, or configured with SL-U configuration described at reference 706 in FIG. 7A, or reconfigured or active at reference 716 in FIG. 7A). In some aspects, the transmitter UE 120 may further transmit retransmission(s) of the first TB of the set of TBs (e.g., blind retransmissions, if enabled via configuration or activation) without LBT procedure if the time gap between the initial transmission of the first TB and the retransmission(s) of the first TB is below a threshold (for a transmission burst). In some aspects, the transmitter UE 120 may further transmit an initial transmission of a second TB of the set of TBs with LBT at reference 735 (e.g., type 2 LBT for sharing the COT) if the time gap between the initial transmission of the first TB and the initial transmission of the second TB is above a threshold (for continuous transmission) or below a threshold (for COT sharing) (e.g., the threshold may be preconfigured or indicated from upper layer such as service layer or application layer with the sidelink unlicensed configuration for a sidelink communication QoS described at reference 701 or reference 702 in FIG. 7A, or configured with SL-U configuration described at reference 706 in FIG. 7A, or reconfigured or active at reference 716 in FIG. 7A). In some aspects, the transmitter UE 120 may further transmit retransmission(s) of the first TB of the set of TBs with LBT at reference 735 (e.g., type 2 LBT for sharing the COT) if the time gap between the initial transmission of the first TB and the retransmission(s) of the first TB is above a threshold (for continuous transmission) or below a threshold (for COT sharing). In some aspects, the initial transmission of the second TB includes a second SL HARQ process number (e.g., in the SCI-2 transmitted with the second TB), where the second HARQ process number is derived based on the HARQ process number indicated in the first DCI. The transmitter UE 120 may transmit initial transmissions of additional TBs from the set of TBs in a similar manner.

As shown in FIG. 7C at reference 736, the receiver UE 120 may transmit, and the transmitter UE 120 may receive, acknowledgment information (e.g., an ACK or a NACK) associated with the initial transmission of the first TB. In some aspects, the receiver UE 120 transmits the acknowledgment information associated with the first TB after performing a successful LBT procedure.

Similarly, as shown at reference 738, the receiver UE 120 may transmit, and the transmitter UE 120 may receive, acknowledgment information (e.g., an ACK or a NACK) associated with the initial transmission of the second TB. In some aspects, the receiver UE 120 transmits the acknowledgment information associated with the second TB after performing a successful LBT procedure. The receiver UE 120 may transmit acknowledgment information associated with initial transmissions of additional TBs from the set of TBs in a similar manner. In some aspects, the receiver UE 120 may transmit the acknowledgment information associated with multiple continuously transmitted TBs of the set of TBs after one successful LBT, for example, via multiple 1-bit PSFCHs (e.g., each carrying an ACK or NACK for a TB) at one PSFCH symbol or multiple PSFCH symbols, or via a multiple-bit PSFCH (e.g., carrying multiple ACKs and/or NACKs for multiple TBs respectively).

In some aspects, as shown at reference 739, the transmitter UE 120 may transmit an acknowledgment (e.g., a one-bit ACK) in a set of resources that is configured, activated, or indicated in the first DCI. The transmitter UE 120 may transmit the acknowledgment if all TBs are received successfully (e.g., if the transmitter UE 120 has received an ACK associated with each TB in the set of TBs after the initial transmissions). In this case, the network node 110 may release resources reserved for first and second transmissions of the set of TBs (e.g., so that the reserved resources can be allocated for other sidelink communications).

As shown at reference 740, the transmitter UE 120 may transmit first retransmissions of one or more TBs in the set of TBs. In some aspects, the one or more TBs for which first retransmissions are performed may be based at least in part on acknowledgment information associated with the initial transmissions, with the acknowledgment information being communicated in resources allocated based on sidelink feedback resources preconfigured or configured for a resource pool or indicated in the SCI transmitted with the TB.

In some aspects, as shown at reference 742, the transmitter UE 120 may transmit an acknowledgment (e.g., a one-bit ACK) in a set of resources that is configured, activated, or indicated in the first DCI. The transmitter UE 120 may transmit the acknowledgment if all TBs are received successfully (e.g., if the transmitter UE 120 has received an ACK associated with each TB in the set of TBs after the first retransmissions). In this case, the network node 110 may release resources reserved for second transmissions of the set of TBs (e.g., so that the reserved resources can be allocated for other sidelink communications).

Alternatively, as shown at reference 744, the transmitter UE 120 may in some aspects transmit second retransmissions of one or more TBs from the set of TBs. In some aspects, the one or more TBs for which second retransmissions are performed may be based at least in part on acknowledgment information associated with the first retransmissions, with the acknowledgment information being communicated in resources that is configured, activated, or indicated in the first DCI. In this case, as shown at reference 746, the transmitter UE 120 may transmit acknowledgment information (e.g., including multiple ACKs/NACKs) associated with the set of TBs. In some aspects, the transmitter UE 120 may transmit the acknowledgment on one or more PUCCHs that is configured, activated, or indicated in the first MCSt grant or on a PUSCH with UCI(s) (e.g., information indicating a quantity of TBs to be retransmitted or a quantity of NACKs) as configured, activated, or indicated in the first DCI.

As shown by reference 748, the network node 110 may determine a set of MCSt parameters (e.g., indicating a set of resources) for a second MCSt grant. In some aspects, the second MCSt may include resource allocations for retransmissions respectively for N2′ TBs (N2′≤N2) based on the acknowledgment information associated with the set of TBs.

As shown at reference 750, the network node 110 may transmit, and the transmitter UE 120 may receive, second DCI indicating the second set of MCSt parameters (e.g., the sidelink resources associated with the second MCSt grant).

As indicated above, FIGS. 7A-7C are provided as examples. Other examples may differ from what is described with respect to FIGS. 7A-7C.

FIG. 8 is a diagram illustrating an example 800 associated with a dynamic grant for multi-TB scheduling in SL-U, in accordance with the present disclosure. In some aspects, a set of MCSt parameters may be indicated in a dynamic grant transmitted by a network node 110, and received by a transmitter UE 120, via DCI.

In some aspects, as described above and as illustrated in FIG. 8, the set of MCSt parameters may include a parameter indicating a first set of N1 (e.g., wherein the value of N1 may be preconfigured, configured, activated or indicated in DCI as described FIGS. 7A-7B) consecutive slots for initial transmissions of a set of N2 (e.g., wherein the value of N2 may be preconfigured, configured, activated or indicated in DCI as described FIGS. 7A-7B) TBs, where the first set of N1 consecutive slots is indicated by a first slot (slot i) in the first set of N1 slots and the first slot (slot i) is indicated by a time gap associated with the first slot (e.g., a time gap between the DCI and the slot i) and a lowest index of a subchannel and subchannel allocation (number of subchannels) of an RB set and/or the index of associated RB set(s) or bitmap of RB sets associated with the first set of consecutive slots.

In some aspects, as described above and as illustrated in FIG. 8, the set of MCSt parameters may include a parameter indicating a second set of N1 consecutive slots (identified in FIG. 8 as a first reserved resource) for first retransmissions of the set of N2 TBs, where the second set of N1 consecutive slots is indicated by a first slot (slot j) in the second set of slots.

In some aspects, as described above and as illustrated in FIG. 8, the set of MCSt parameters may include a parameter indicating a third set of N1 consecutive slots (identified in FIG. 8 as a second reserved resource) for second retransmissions of the set of N2 TBs, where the third set of N1 consecutive slots is indicated by a first slot (slot k) in the third set of slots.

In some aspects, the first set of N1 consecutive slots, the second set of N1 consecutive slots and/or the third set of NJ consecutive slots are contiguous to each other (e.g., with a time gap below a threshold (a threshold for continuous transmission or a threshold for COT sharing) that is preconfigured, configured or activated). In some aspects, the first set of N1 consecutive slots, the second set of N1 consecutive slots and/or the third set of N1 consecutive slots are not contiguous to each other (e.g., with a time gap above a threshold (a threshold for continuous transmission or a threshold for COT sharing) that is preconfigured, configured or activated).

In some aspects, as described above and as illustrated in FIG. 8, the set of MCSt parameters may include a parameter indicating a set of resources associated with indicating acknowledgment of the initial transmissions (e.g., as shown at reference 840 in FIG. 8) or a set of resources associated with indicating acknowledgment of the first retransmissions (e.g., identified as PUCCH for all ACKs as shown at reference 850 in FIG. 8).

In some aspects, as described above and as illustrated in FIG. 8, the set of MCSt parameters may include a parameter indicating a set of resources associated with transmitting acknowledgment information associated with the set of TBs (identified as PUCCHs or PUSCH with UCI(s) as shown at reference 860 in FIG. 8).

In some aspects, as described above and as illustrated in FIG. 8, the set of MCSt parameters may include a parameter indicating a HARQ process numbery associated with one or more TBs of the set of TBs. For example, in a first MCSt grant, a HARQ process number may be associated with the set of N2 TBs (with NDI toggled with a first or initial grant for HARQ process numbery). As another example, in a second MCSt grant, the HARQ process number may be associated with a subset of TBs of the set of N2 TBs (with NDI not toggled for retransmissions with a second grant for HARQ process numbery).

In some aspects, as described above and as illustrated in FIG. 8, the set of MCSt parameters may include a parameter indicating a subchannel allocation (number of subchannels) of one or more RB sets configuration for the set of TBs. Here, the parameter may be, for example, a code point, an index, or an identifier corresponding to a subchannel allocation configuration of one or more RB sets (e.g., a resource pattern as shown at a reference 810 or reference 830 or as shown at reference 820 in FIG. 8) to be used for the set for N2 TBs. In some aspects, if such a parameter is not indicated, then the transmitter UE 120 may use a pre-configured, configured or activated subchannel allocation of one or more RB sets or the same subchannel allocation of one or more RB sets for each TB in the set of TBs.

In some aspects, as described above and as illustrated in FIG. 8, the set of MCSt parameters indicated in a sidelink grant may include a parameter indicating the quantity of slots (e.g., N1) of a set of N1 consecutive slots.

In some aspects, as described above and as illustrated in FIG. 8, the set of MCSt parameters indicated in a sidelink grant may include a parameter indicating the quantity of TBs (e.g., N2) of the set of N2 TBs.

In some aspects, as described above and as illustrated in FIG. 8, the LBT occasions may be derived from value N1 and N2. For example, LBT occasions for each TB

$${LBT\_occasion}_{T B} = ⌊ \frac{N 1}{N 2} ⌋$$

for the resource pattern shown at reference 810 and reference 830 in FIG. 8 (e.g., in the case using LBT type 2 for each TB transmission sharing the COT). For another example, LBT occasions for the first TB LBT_occasion_{TB1}=N1−N2+1 for the resource pattern shown at reference 820 in FIG. 8 (e.g., continuous transmissions without LBT after the first TB's transmission). In some aspects, as described above and as illustrated in FIG. 8, the maximum LBT occasions for the first TB may be up to value NJ. For example, the first TB may be initially transmitted with a successful LBT in slot i+z (where z=0, . . . , N1−1) and then the remaining slots of the set of N1 consecutive slots may be used for blind retransmission(s) of the first TB and/or the initial transmissions respectively for other TBs (where the number of other TBs is based on the number of remaining slots of the set of N1 consecutive slots, for example, filling in the remaining slots with other TBs' initial transmissions).

As indicated above, FIG. 8 is provided as an example. Other examples may differ from what is described with respect to FIG. 8.

FIG. 9 is a diagram illustrating an example process 900 performed, for example, by a transmitter UE, in accordance with the present disclosure. Example process 900 is an example where the transmitter UE (e.g., UE 120) performs operations associated with multi-TB scheduling for SL-U.

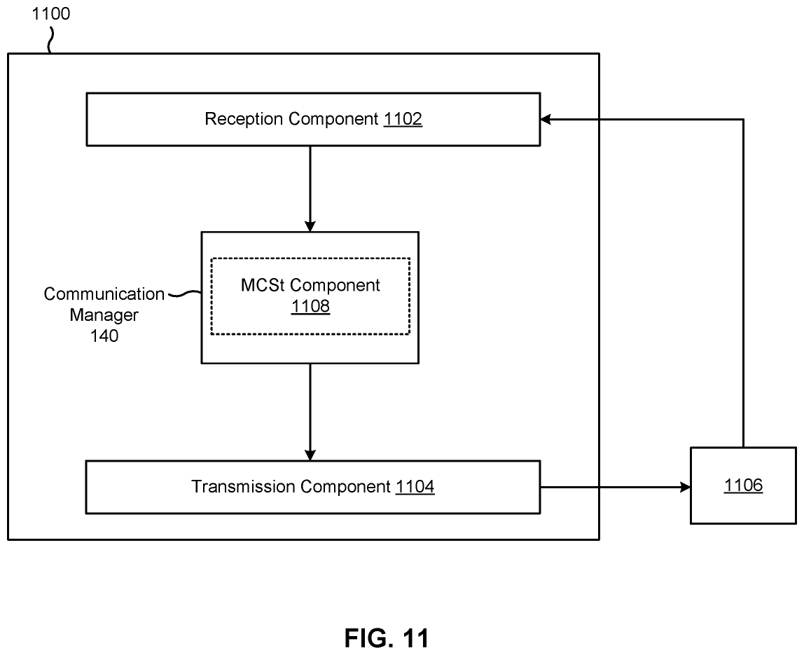

As shown in FIG. 9, in some aspects, process 900 may include transmitting sidelink information associated with the transmitter UE, the sidelink information including information associated with sidelink communication of the transmitter UE in an unlicensed spectrum (block 910). For example, the transmitter UE (e.g., using communication manager 140 and/or transmission component 1104, depicted in FIG. 11) may transmit sidelink information associated with the transmitter UE, the sidelink information including information associated with sidelink communication of the transmitter UE in an unlicensed spectrum, as described above.

As further shown in FIG. 9, in some aspects, process 900 may include receiving an indication indicating a set of MCSt parameters to be used in association with transmitting a set of MCSt transmissions for reception by a receiver UE in the unlicensed spectrum (block 920). For example, the transmitter UE (e.g., using communication manager 140 and/or reception component 1102, depicted in FIG. 11) may receive an indication indicating a set of MCSt parameters to be used in association with transmitting a set of MCSt transmissions for reception by a receiver UE in the unlicensed spectrum, as described above.

Process 900 may include additional aspects, such as any single aspect or any combination of aspects described below and/or in connection with one or more other processes described elsewhere herein.

In a first aspect, process 900 includes transmitting at least one MCSt transmission on sidelink for reception by the receiver UE based at least in part on the set of MCSt parameters.

In a second aspect, alone or in combination with the first aspect, the sidelink information includes information associated with support of the transmitter UE for MCSt transmissions.

In a third aspect, alone or in combination with one or more of the first and second aspects, the information associated with support of the transmitter UE for MCSt transmissions includes at least one of an indication that the transmitter UE supports MCSt transmissions or an indication of a maximum number of transport blocks supported by the transmitter UE in association with MCSt transmissions.

In a fourth aspect, alone or in combination with one or more of the first through third aspects, the sidelink information includes information associated with support of the receiver UE for MCSt transmissions.

In a fifth aspect, alone or in combination with one or more of the first through fourth aspects, process 900 includes receiving the information associated with support of the receiver UE for MCSt transmissions from the receiver UE.

In a sixth aspect, alone or in combination with one or more of the first through fifth aspects, the indication includes a sidelink unlicensed configuration received via RRC signaling, the sidelink unlicensed configuration including an MCSt configuration indicating the set of MCSt parameters.

In a seventh aspect, alone or in combination with one or more of the first through sixth aspects, the set of MCSt parameters includes at least one of a quantity of slots in a set of slots associated with transmitting a set of TBs, a quantity of TBs in the set of TBs, or a subchannel allocation associated with transmitting MCSt transmissions.

In an eighth aspect, alone or in combination with one or more of the first through seventh aspects, process 900 includes transmitting the sidelink unlicensed configuration for reception by the receiver UE via RRC signaling on sidelink.

In a ninth aspect, alone or in combination with one or more of the first through eighth aspects, the sidelink information includes information associated with a performance of the transmitter UE with respect to operation in the unlicensed spectrum.

In a tenth aspect, alone or in combination with one or more of the first through ninth aspects, the information associated with the performance of the transmitter UE includes at least one of an indication of a LBT success rate, an indication of an LBT failure rate, or an indication of a quantity of LBT failures.

In an eleventh aspect, alone or in combination with one or more of the first through tenth aspects, the indication of the LBT success rate, the indication of the LBT failure rate, or the indication of the quantity of LBT failures is indicated per RB set.

In a twelfth aspect, alone or in combination with one or more of the first through eleventh aspects, the indication includes a reconfiguration message received via a RRC signaling, the reconfiguration message including information associated with reconfiguring the set of MCSt parameters.

In a thirteenth aspect, alone or in combination with one or more of the first through twelfth aspects, process 900 includes transmitting the reconfiguration message for reception by the receiver UE via RRC signaling on sidelink.

In a fourteenth aspect, alone or in combination with one or more of the first through thirteenth aspects, the indication includes an activation message received via a MAC CE, the activation message including information associated with activating the set of MCSt parameters.

In a fifteenth aspect, alone or in combination with one or more of the first through fourteenth aspects, process 900 includes transmitting the activation message for reception by the receiver UE via a MAC CE on sidelink.

In a sixteenth aspect, alone or in combination with one or more of the first through fifteenth aspects, the sidelink information includes an indication of a preferred value for an MCSt parameter.

In a seventeenth aspect, alone or in combination with one or more of the first through sixteenth aspects, process 900 includes determining the preferred value for the MCSt parameter based at least in part on at least one of a QoS associated with a SL BSR, a channel condition associated with the sidelink between the transmitter UE and the receiver UE, or a LBT performance characteristic associated with the transmitter UE.

In an eighteenth aspect, alone or in combination with one or more of the first through seventeenth aspects, the indication includes a dynamic grant received in DCI, the dynamic grant indicating the set of MCSt parameters.

In a nineteenth aspect, alone or in combination with one or more of the first through eighteenth aspects, the dynamic grant is associated with one or more RB sets.

In a twentieth aspect, alone or in combination with one or more of the first through nineteenth aspects, the set of MCSt parameters indicates a first set of consecutive slots for initial transmissions of a set of TBs.

In a twenty-first aspect, alone or in combination with one or more of the first through twentieth aspects, the first set of consecutive slots is indicated by a first slot in the set of slots, the first slot being indicated by a time gap associated with the first slot and a lowest index of a subchannel allocation associated with the first set of consecutive slots.

In a twenty-second aspect, alone or in combination with one or more of the first through twenty-first aspects, the set of MCSt parameters includes at least one of an indication of a second set of consecutive slots for first retransmissions associated with the set of TBs, or an indication of a third set of consecutive slots for second retransmissions associated with the set of TBs.

In a twenty-third aspect, alone or in combination with one or more of the first through twenty-second aspects, the set of MCSt parameters includes at least one of a set of resources associated with indicating acknowledgment of the initial transmissions or a set of resources associated with indicating acknowledgment of the first retransmissions.

In a twenty-fourth aspect, alone or in combination with one or more of the first through twenty-third aspects, the set of MCSt parameters includes a set of resources to be used associated with transmitting acknowledgment information associated with a set of TBs.

In a twenty-fifth aspect, alone or in combination with one or more of the first through twenty-fourth aspects, the set of resources comprises a set of UCI resources in a PUSCH.

In a twenty-sixth aspect, alone or in combination with one or more of the first through twenty-fifth aspects, the set of MCSt parameters includes at least one of a HARQ process number associated with one or more TBs of a set of TBs, an indication of a subchannel allocation configuration for the set of TBs, an indication of a quantity of slots in a set of consecutive slots, or an indication of a quantity of TBs.

In a twenty-seventh aspect, alone or in combination with one or more of the first through twenty-sixth aspects, process 900 includes performing a LBT procedure at a plurality of LBT occasions based at least in part on the set of MCSt parameters, the plurality of LBT occasions being associated with a transmission of each TB of a set of TBs.

In a twenty-eighth aspect, alone or in combination with one or more of the first through twenty-seventh aspects, process 900 includes deriving a first SL HARQ process number associated with a first TB of a set of TBs based at least in part on a HARQ process number included in a sidelink grant in DCI, and transmitting an initial transmission of the first TB, the initial transmission including SCI indicating the first SL HARQ process number.

In a twenty-ninth aspect, alone or in combination with one or more of the first through twenty-eighth aspects, process 900 includes deriving a second SL HARQ process number associated with a second TB of the set of TBs based at least in part on the HARQ process number included the sidelink grant in DCI, and transmitting an initial transmission of the second TB, the initial transmission including SCI indicating the second SL HARQ process number.

In a thirtieth aspect, alone or in combination with one or more of the first through twenty-ninth aspects, process 900 includes receiving sidelink feedback information indicating that all TBs in a set of TBs have been received by the receiver UE, and transmitting, on uplink, an acknowledgment associated with the set of TBs, the acknowledgment being transmitted in a set of resources indicated by the set of MCSt parameters.

In a thirty-first aspect, alone or in combination with one or more of the first through thirtieth aspects, process 900 includes receiving sidelink feedback information associated with a set of TBs transmitted for reception by the receiver UE, and transmitting, on uplink, acknowledgment information associated with the set of TBs, the acknowledgment information being transmitted in a set of resources indicated by the set of MCSt parameters.

In a thirty-second aspect, alone or in combination with one or more of the first through thirty-first aspects, process 900 includes receiving a second indication indicating a second sidelink grant with a second set of MCSt parameters to be used in association with transmitting one or more retransmissions associated with the set of MCSt transmissions, and transmitting at least one MCSt transmission on sidelink for reception by the receiver UE based at least in part on the second sidelink grant with the second set of MCSt parameters.

In a thirty-third aspect, alone or in combination with one or more of the first through twenty-second aspects, the set of MCSt parameters is based at least in part on the sidelink information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with multi-TB scheduling for SL-U.

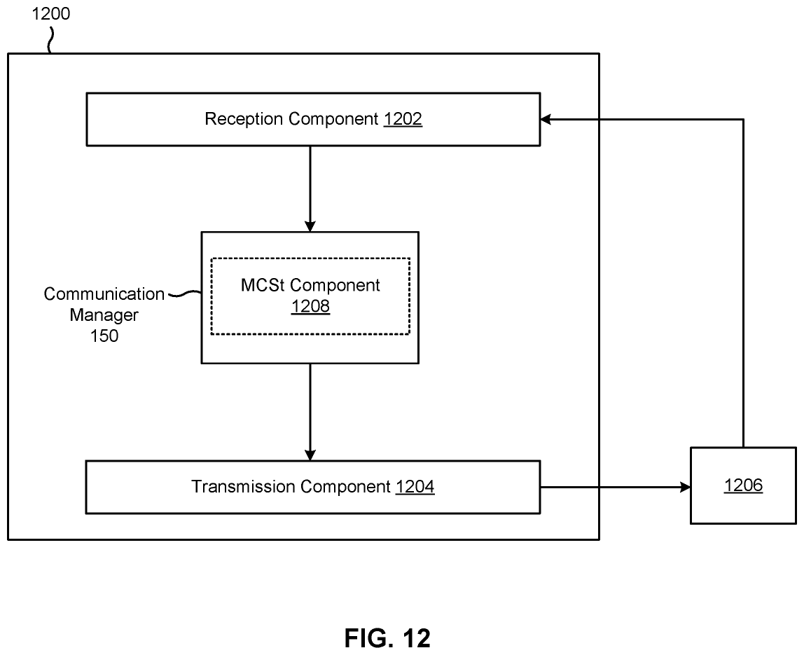

As shown in FIG. 10, in some aspects, process 1000 may include receiving sidelink information associated with a transmitter UE, the sidelink information including information associated with sidelink communication of the transmitter UE in an unlicensed spectrum (block 1010). For example, the network node (e.g., using communication manager 150 and/or reception component 1202, depicted in FIG. 12) may receive sidelink information associated with a transmitter UE, the sidelink information including information associated with sidelink communication of the transmitter UE in an unlicensed spectrum, as described above.

As further shown in FIG. 10, in some aspects, process 1000 may include determining a set of MCSt parameters to be used by the transmitter UE in association with transmitting a set of MCSt transmissions for reception by a receiver UE in the unlicensed spectrum (block 1020). For example, the network node (e.g., using communication manager 150 and/or MCSt component 1208, depicted in FIG. 12) may determine a set of MCSt parameters to be used by the transmitter UE in association with transmitting a set of MCSt transmissions for reception by a receiver UE in the unlicensed spectrum, as described above.

As further shown in FIG. 10, in some aspects, process 1000 may include transmitting an indication indicating the set of MCSt parameters for reception by the transmitter UE (block 1030). For example, the network node (e.g., using communication manager 150 and/or transmission component 1204, depicted in FIG. 12) may transmit an indication indicating the set of MCSt parameters for reception by the transmitter UE, as described above.

Process 1000 may include additional aspects, such as any single aspect or any combination of aspects described below and/or in connection with one or more other processes described elsewhere herein.

In a first aspect, the sidelink information includes information associated with support of the transmitter UE for MCSt transmissions.

In a second aspect, alone or in combination with the first aspect, the information associated with support of the transmitter UE for MCSt transmissions includes at least one of an indication that the transmitter UE supports MCSt transmissions or an indication of a maximum number of transport blocks supported by the transmitter UE in association with MCSt transmissions.

In a third aspect, alone or in combination with one or more of the first and second aspects, the sidelink information includes information associated with support of the receiver UE for MCSt transmissions.

In a fourth aspect, alone or in combination with one or more of the first through third aspects, the indication includes a sidelink unlicensed configuration transmitted via RRC signaling, the sidelink unlicensed configuration including an MCSt configuration indicating the set of MCSt parameters.

In a fifth aspect, alone or in combination with one or more of the first through fourth aspects, the set of MCSt parameters includes at least one of a quantity of slots in a set of slots associated with transmitting a set of TBs, a quantity of TBs in the set of TBs, or a subchannel allocation associated with transmitting MCSt transmissions.

In a sixth aspect, alone or in combination with one or more of the first through fifth aspects, the sidelink information includes information associated with a performance of the transmitter UE with respect to operation in the unlicensed spectrum.

In a seventh aspect, alone or in combination with one or more of the first through sixth aspects, the information associated with the performance of the transmitter UE includes at least one of an indication of a LBT success rate, an indication of an LBT failure rate, or an indication of a quantity of LBT failures.

In an eighth aspect, alone or in combination with one or more of the first through seventh aspects, the indication of the LBT success rate, the indication of the LBT failure rate, or the indication of the quantity of LBT failures is indicated per RB set.

In a ninth aspect, alone or in combination with one or more of the first through eighth aspects, the indication includes a reconfiguration message transmitted via a RRC signaling, the reconfiguration message including information associated with reconfiguring the set of MCSt parameters.

In a tenth aspect, alone or in combination with one or more of the first through ninth aspects, the indication includes an activation message transmitted via a MAC CE, the activation message including information associated with activating the set of MCSt parameters.

In an eleventh aspect, alone or in combination with one or more of the first through tenth aspects, the sidelink information includes an indication of a preferred value for an MCSt parameter.

In a twelfth aspect, alone or in combination with one or more of the first through eleventh aspects, the indication includes a dynamic grant transmitted in DCI, the dynamic grant indicating the set of MCSt parameters.

In a thirteenth aspect, alone or in combination with one or more of the first through twelfth aspects, the dynamic grant is associated with one or more RB sets.

In a fourteenth aspect, alone or in combination with one or more of the first through thirteenth aspects, process 1000 includes selecting the one or more RB sets based at least in part on the sidelink information associated with the transmitter UE.

In a fifteenth aspect, alone or in combination with one or more of the first through fourteenth aspects, the set of MCSt parameters indicates a first set of consecutive slots for initial transmissions of a set of TBs.

In a sixteenth aspect, alone or in combination with one or more of the first through fifteenth aspects, the first set of consecutive slots is indicated by a first slot in the set of slots, the first slot being indicated by a time gap associated with the first slot and a lowest index of a subchannel allocation associated with the first set of consecutive slots.

In a seventeenth aspect, alone or in combination with one or more of the first through sixteenth aspects, the set of MCSt parameters includes at least one of an indication of a second set of consecutive slots for first retransmissions associated with the set of TBs, or an indication of a third set of consecutive slots for second retransmissions associated with the set of TBs.

In an eighteenth aspect, alone or in combination with one or more of the first through seventeenth aspects, the set of MCSt parameters includes at least one of a set of resources associated with indicating acknowledgment of the initial transmissions or a set of resources associated with indicating acknowledgment of the first retransmissions.

In a nineteenth aspect, alone or in combination with one or more of the first through eighteenth aspects, the set of MCSt parameters includes a set of resources to be used by the transmitter UE associated with transmitting acknowledgment information associated with a set of TBs.

In a twentieth aspect, alone or in combination with one or more of the first through nineteenth aspects, the set of resources comprises a set of UCI resources in a PUSCH.

In a twenty-first aspect, alone or in combination with one or more of the first through twentieth aspects, the set of MCSt parameters includes at least one of a HARQ process number associated with one or more TBs of a set of TBs, an indication of a subchannel allocation configuration for the set of TBs, an indication of a quantity of slots in a set of consecutive slots, or an indication of a quantity of TBs.

In a twenty-second aspect, alone or in combination with one or more of the first through twenty-first aspects, process 1000 includes receiving, on uplink, an acknowledgment associated with a set of TBs, the acknowledgment being received in a set of resources indicated by the set of MCSt parameters.

In a twenty-third aspect, alone or in combination with one or more of the first through twenty-second aspects, process 1000 includes receiving, on uplink, acknowledgment information associated with a set of TBs, the acknowledgment information being received in a set of resources indicated by the set of MCSt parameters.

In a twenty-fourth aspect, alone or in combination with one or more of the first through twenty-third aspects, process 1000 includes determining, based at least in part on the acknowledgment information, a second sidelink grant with a second set of MCSt parameters to be used by the transmitter UE in association with transmitting one or more retransmissions associated with the set of MCSt transmissions, and transmitting a second indication indicating the second sidelink grant with the second set of MCSt parameters.

In a twenty-fifth aspect, alone or in combination with one or more of the first through twenty-fourth aspects, the set of MCSt parameters is determined based at least in part on the sidelink information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include an MCSt component 1108, among other examples.

In some aspects, the apparatus 1100 may be configured to perform one or more operations described herein in connection with FIGS. 6, 7A-7C, and 8. Additionally, or alternatively, the apparatus 1100 may be configured to perform one or more processes described herein, such as process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The transmission component 1104 may transmit sidelink information associated with the transmitter UE, the sidelink information including information associated with sidelink communication of the transmitter UE in an unlicensed spectrum. The reception component 1102 may receive an indication indicating a set of MCSt parameters to be used in association with transmitting a set of MCSt transmissions for reception by a receiver UE in the unlicensed spectrum.

The transmission component 1104 may transmit at least one MCSt transmission on sidelink for reception by the receiver UE based at least in part on the set of MCSt parameters.

The reception component 1102 may receive the information associated with support of the receiver UE for MCSt transmissions from the receiver UE.

The transmission component 1104 may transmit the sidelink unlicensed configuration for reception by the receiver UE via RRC signaling on sidelink.

The transmission component 1104 may transmit the reconfiguration message for reception by the receiver UE via RRC signaling on sidelink.

The transmission component 1104 may transmit the activation message for reception by the receiver UE via a MAC CE on sidelink.

The MCSt component 1108 may determine the preferred value for the MCSt parameter based at least in part on at least one of a QoS associated with a sidelink between the transmitter UE and the receiver UE, a channel condition associated with the sidelink between the transmitter UE and the receiver UE, or a LBT performance characteristic associated with the transmitter UE.

The MCSt component 1108 may perform a LBT procedure at a plurality of LBT occasions based at least in part on the set of MCSt parameters, the plurality of LBT occasions being associated with a transmission of each TB of a set of TBs.

The MCSt component 1108 may derive a first SL HARQ process number associated with a first TB of a set of TBs based at least in part on a HARQ process number included in the set of MCSt parameters.

The transmission component 1104 may transmit an initial transmission of the first TB, the initial transmission including SCI indicating the first SL HARQ process number.

The MCSt component 1108 may derive a second SL HARQ process number associated with a second TB of the set of TBs based at least in part on the HARQ process number included in the set of MCSt parameters.

The transmission component 1104 may transmit an initial transmission of the second TB, the initial transmission including SCI indicating the second SL HARQ process number.

The reception component 1102 may receive sidelink feedback information indicating that all TBs in a set of TBs have been received by the receiver UE.

The transmission component 1104 may transmit, on uplink, an acknowledgment associated with the set of TBs, the acknowledgment being transmitted in a set of resources indicated by the set of MCSt parameters.

The reception component 1102 may receive sidelink feedback information associated with a set of TBs transmitted for reception by the receiver UE.

The transmission component 1104 may transmit, on uplink, acknowledgment information associated with the set of TBs, the acknowledgment information being transmitted in a set of resources indicated by the set of MCSt parameters.

The reception component 1102 may receive a second indication indicating a second set of MCSt parameters to be used in association with transmitting one or more retransmissions associated with the set of MCSt transmissions.

The transmission component 1104 may transmit at least one MCSt transmission on sidelink for reception by the receiver UE based at least in part on the second set of MCSt parameters.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include an MCSt component 1208, among other examples.

In some aspects, the apparatus 1200 may be configured to perform one or more operations described herein in connection with FIGS. 6, 7A-7C, and 8. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The reception component 1202 may receive sidelink information associated with a transmitter UE, the sidelink information including information associated with sidelink communication of the transmitter UE in an unlicensed spectrum. The MCSt component 1208 may determine a set of MCSt parameters to be used by the transmitter UE in association with transmitting a set of MCSt transmissions for reception by a receiver UE in the unlicensed spectrum. The transmission component 1204 may transmit an indication indicating the set of MCSt parameters for reception by the transmitter UE.

The MCSt component 1208 may select the one or more RB sets based at least in part on the sidelink information associated with the transmitter UE.

The reception component 1202 may receive, on uplink, an acknowledgment associated with a set of TBs, the acknowledgment being received in a set of resources indicated by the set of MCSt parameters.

The reception component 1202 may receive, on uplink, acknowledgment information associated with a set of TBs, the acknowledgment information being received in a set of resources indicated by the set of MCSt parameters.

The MCSt component 1208 may determine, based at least in part on the acknowledgment information, a second set of MCSt parameters to be used by the transmitter UE in association with transmitting one or more retransmissions associated with the set of MCSt transmissions.

The transmission component 1204 may transmit a second indication indicating the second set of MCSt parameters.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a transmitter UE, comprising: transmitting sidelink information associated with the transmitter UE, the sidelink information including information associated with sidelink communication of the transmitter UE in an unlicensed spectrum; and receiving an indication indicating a set of MCSt parameters to be used in association with transmitting a set of MCSt transmissions for reception by a receiver UE in the unlicensed spectrum.
Aspect 2: The method of Aspect 1, further comprising transmitting at least one MCSt transmission on sidelink for reception by the receiver UE based at least in part on the set of MCSt parameters.
Aspect 3: The method of any of Aspects 1-2, wherein the sidelink information includes information associated with support of the transmitter UE for MCSt transmissions.
Aspect 4: The method of Aspect 3, wherein the information associated with support of the transmitter UE for MCSt transmissions includes at least one of an indication that the transmitter UE supports MCSt transmissions or an indication of a maximum number of transport blocks supported by the transmitter UE in association with MCSt transmissions.
Aspect 5: The method of any of Aspects 1-4, wherein the sidelink information includes information associated with support of the receiver UE for MCSt transmissions.
Aspect 6: The method of Aspect 5, further comprising receiving the information associated with support of the receiver UE for MCSt transmissions from the receiver UE.
Aspect 7: The method of any of Aspects 1-6, wherein the indication includes a sidelink unlicensed configuration received via RRC signaling, the sidelink unlicensed configuration including an MCSt configuration indicating the set of MCSt parameters.
Aspect 8: The method of Aspect 7, wherein the set of MCSt parameters includes at least one of a quantity of slots in a set of slots associated with transmitting a set of transport blocks (TBs), a quantity of TBs in the set of TBs, or a subchannel allocation associated with transmitting MCSt transmissions.
Aspect 9: The method of Aspect 7, further comprising transmitting the sidelink unlicensed configuration for reception by the receiver UE via RRC signaling on sidelink.
Aspect 10: The method of any of Aspects 1-9, wherein the sidelink information includes information associated with a performance of the transmitter UE with respect to operation in the unlicensed spectrum.
Aspect 11: The method of Aspect 10, wherein the information associated with the performance of the transmitter UE includes at least one of an indication of a LBT success rate, an indication of an LBT failure rate, or an indication of a quantity of LBT failures.
Aspect 12: The method of Aspect 11, wherein the indication of the LBT success rate, the indication of the LBT failure rate, or the indication of the quantity of LBT failures is indicated per RB set.
Aspect 13: The method of any of Aspects 1-12, wherein the indication includes a reconfiguration message received via a RRC signaling, the reconfiguration message including information associated with reconfiguring the set of MCSt parameters.
Aspect 14: The method of Aspect 13, further comprising transmitting the reconfiguration message for reception by the receiver UE via RRC signaling on sidelink.
Aspect 15: The method of any of Aspects 1-14, wherein the indication includes an activation message received via a MAC CE, the activation message including information associated with activating the set of MCSt parameters.
Aspect 16: The method of Aspect 15, further comprising transmitting the activation message for reception by the receiver UE via a MAC CE on sidelink.
Aspect 17: The method of any of Aspects 1-16, wherein the sidelink information includes an indication of a preferred value for an MCSt parameter.
Aspect 18: The method of Aspect 17, further comprising determining the preferred value for the MCSt parameter based at least in part on at least one of: a QoS associated with a SL BSR, a channel condition associated with the sidelink between the transmitter UE and the receiver UE, or a LBT performance characteristic associated with the transmitter UE.
Aspect 19: The method of any of Aspects 1-18, wherein the indication includes a dynamic grant received in DCI, the dynamic grant indicating the set of MCSt parameters.
Aspect 20: The method of Aspect 19, wherein the dynamic grant is associated with one or more RB sets.
Aspect 21: The method of any of Aspects 1-20, wherein the set of MCSt parameters indicates a first set of consecutive slots for initial transmissions of a set of TBs.
Aspect 22: The method of Aspect 21, wherein the first set of consecutive slots is indicated by a first slot in the set of slots, the first slot being indicated by a time gap associated with the first slot and a lowest index of a subchannel allocation associated with the first set of consecutive slots.
Aspect 23: The method of Aspect 21, wherein the set of MCSt parameters includes at least one of: an indication of a second set of consecutive slots for first retransmissions associated with the set of TBs, or an indication of a third set of consecutive slots for second retransmissions associated with the set of TBs.
Aspect 24: The method of Aspect 23, wherein the set of MCSt parameters includes at least one of a set of resources associated with indicating acknowledgment of the initial transmissions or a set of resources associated with indicating acknowledgment of the first retransmissions.
Aspect 25: The method of any of Aspects 1-24, wherein the set of MCSt parameters includes a set of resources to be used associated with transmitting acknowledgment information associated with a set of TBs.
Aspect 26: The method of Aspect 25, wherein the set of resources comprises a set of UCI resources in a PUSCH.
Aspect 27: The method of any of Aspects 1-26, wherein the set of MCSt parameters includes at least one of: a HARQ process number associated with one or more TBs of a set of TBs, an indication of a subchannel allocation configuration for the set of TBs, an indication of a quantity of slots in a set of consecutive slots, or an indication of a quantity of TBs.
Aspect 28: The method of any of Aspects 1-27, further comprising performing a LBT procedure at a plurality of LBT occasions based at least in part on the set of MCSt parameters, the plurality of LBT occasions being associated with a transmission of each TB of a set of TBs.
Aspect 29: The method of any of Aspects 1-28, further comprising: deriving a first SL HARQ process number associated with a first TB of a set of TBs based at least in part on a HARQ process number included in a sidelink grant in DCI; and transmitting an initial transmission of the first TB, the initial transmission including SCI indicating the first SL HARQ process number.
Aspect 30: The method of Aspect 29, further comprising: deriving a second SL HARQ process number associated with a second TB of the set of TBs based at least in part on the HARQ process number included in the sidelink grant in DCI; and transmitting an initial transmission of the second TB, the initial transmission including SCI indicating the second SL HARQ process number.
Aspect 31: The method of any of Aspects 1-30, further comprising: receiving sidelink feedback information indicating that all TBs in a set of TBs have been received by the receiver UE, and transmitting, on uplink, an acknowledgment associated with the set of TBs, the acknowledgment being transmitted in a set of resources indicated by the set of MCSt parameters.
Aspect 32: The method of any of Aspects 1-31, further comprising: receiving sidelink feedback information associated with a set of TBs transmitted for reception by the receiver UE, and transmitting, on uplink, acknowledgment information associated with the set of TBs, the acknowledgment information being transmitted in a set of resources indicated by the set of MCSt parameters.
Aspect 33: The method of any of Aspects 1-32, further comprising: receiving a second indication indicating a second sidelink grant with a second set of MCSt parameters to be used in association with transmitting one or more retransmissions associated with the set of MCSt transmissions; and transmitting at least one MCSt transmission on sidelink for reception by the receiver UE based at least in part on the second sidelink grant with the second set of MCSt parameters.
Aspect 34: The method of any of Aspects 1-33, wherein the set of MCSt parameters is based at least in part on the sidelink information.
Aspect 35: A method of wireless communication performed by a network node, comprising: receiving sidelink information associated with a transmitter UE, the sidelink information including information associated with sidelink communication of the transmitter UE in an unlicensed spectrum; determining a set of MCSt parameters to be used by the transmitter UE in association with transmitting a set of MCSt transmissions for reception by a receiver UE in the unlicensed spectrum; and transmitting an indication indicating the set of MCSt parameters for reception by the transmitter UE.
Aspect 36: The method of Aspect 35, wherein the sidelink information includes information associated with support of the transmitter UE for MCSt transmissions.
Aspect 37: The method of Aspect 36, wherein the information associated with support of the transmitter UE for MCSt transmissions includes at least one of an indication that the transmitter UE supports MCSt transmissions or an indication of a maximum number of transport blocks supported by the transmitter UE in association with MCSt transmissions.
Aspect 38: The method of any of Aspects 35-37, wherein the sidelink information includes information associated with support of the receiver UE for MCSt transmissions.
Aspect 39: The method of any of Aspects 35-38, wherein the indication includes a sidelink unlicensed configuration transmitted via RRC signaling, the sidelink unlicensed configuration including an MCSt configuration indicating the set of MCSt parameters.
Aspect 40: The method of Aspect 39, wherein the set of MCSt parameters includes at least one of a quantity of slots in a set of slots associated with transmitting a set of TBs, a quantity of TBs in the set of TBs, or a subchannel allocation associated with transmitting MCSt transmissions.
Aspect 41: The method of any of Aspects 35-40, wherein the sidelink information includes information associated with a performance of the transmitter UE with respect to operation in the unlicensed spectrum.
Aspect 42: The method of Aspect 41, wherein the information associated with the performance of the transmitter UE includes at least one of an indication of a LBT success rate, an indication of an LBT failure rate, or an indication of a quantity of LBT failures.
Aspect 43: The method of Aspect 42, wherein the indication of the LBT success rate, the indication of the LBT failure rate, or the indication of the quantity of LBT failures is indicated per RB set.
Aspect 44: The method of any of Aspects 3543, wherein the indication includes a reconfiguration message transmitted via a RRC signaling, the reconfiguration message including information associated with reconfiguring the set of MCSt parameters.
Aspect 45: The method of any of Aspects 35-44, wherein the indication includes an activation message transmitted via a MAC CE, the activation message including information associated with activating the set of MCSt parameters.
Aspect 46: The method of any of Aspects 3545, wherein the sidelink information includes an indication of a preferred value for an MCSt parameter.
Aspect 47: The method of any of Aspects 35-46, wherein the indication includes a dynamic grant transmitted in DCI, the dynamic grant indicating the set of MCSt parameters.
Aspect 48: The method of Aspect 47, wherein the dynamic grant is associated with one or more RB sets.
Aspect 49: The method of Aspect 48, further comprising selecting the one or more RB sets based at least in part on the sidelink information associated with the transmitter UE.
Aspect 50: The method of any of Aspects 3549, wherein the set of MCSt parameters indicates a first set of consecutive slots for initial transmissions of a set of TBs.
Aspect 51: The method of Aspect 50, wherein the first set of consecutive slots is indicated by a first slot in the set of slots, the first slot being indicated by a time gap associated with the first slot and a lowest index of a subchannel allocation associated with the first set of consecutive slots.
Aspect 52: The method of Aspect 50, wherein the set of MCSt parameters includes at least one of: an indication of a second set of consecutive slots for first retransmissions associated with the set of TBs, or an indication of a third set of consecutive slots for second retransmissions associated with the set of TBs.
Aspect 53: The method of Aspect 52, wherein the set of MCSt parameters includes at least one of a set of resources associated with indicating acknowledgment of the initial transmissions or a set of resources associated with indicating acknowledgment of the first retransmissions.
Aspect 54: The method of any of Aspects 35-53, wherein the set of MCSt parameters includes a set of resources to be used by the transmitter UE associated with transmitting acknowledgment information associated with a set of TBs.
Aspect 55: The method of Aspect 54, wherein the set of resources comprises a set of UCI resources in a PUSCH.
Aspect 56: The method of any of Aspects 35-55, wherein the set of MCSt parameters includes at least one of: a HARQ process number associated with one or more TBs of a set of TBs, an indication of a subchannel allocation configuration for the set of TBs, an indication of a quantity of slots in a set of consecutive slots, or an indication of a quantity of TBs.
Aspect 57: The method of any of Aspects 35-56, further comprising receiving, on uplink, an acknowledgment associated with a set of TBs, the acknowledgment being received in a set of resources indicated by the set of MCSt parameters.
Aspect 58: The method of any of Aspects 35-57, further comprising receiving, on uplink, acknowledgment information associated with a set of TBs, the acknowledgment information being received in a set of resources indicated by the set of MCSt parameters.
Aspect 59: The method of Aspect 58, further comprising: determining, based at least in part on the acknowledgment information, a second sidelink grant with a second set of MCSt parameters to be used by the transmitter UE in association with transmitting one or more retransmissions associated with the set of MCSt transmissions; and transmitting a second indication indicating the second sidelink grant with the second set of MCSt parameters.
Aspect 60: The method of any of Aspects 35-59, wherein the set of MCSt parameters is determined based at least in part on the sidelink information.
Aspect 61: An apparatus for wireless communication at a device, comprising a processor, one or more memories coupled with the processor, and instructions stored in the one or more memories and executable by the processor to cause the apparatus to perform the method of one or more of Aspects 1-60.
Aspect 62: A device for wireless communication, comprising one or more memories and one or more processors coupled to the one or more memories, the one or more processors configured to perform the method of one or more of Aspects 1-60.
Aspect 63: An apparatus for wireless communication, comprising at least one means for performing the method of one or more of Aspects 1-60.
Aspect 64: A non-transitory computer-readable medium storing code for wireless communication, the code comprising instructions executable by a processor to perform the method of one or more of Aspects 1-60.
Aspect 65: A non-transitory computer-readable medium storing a set of instructions for wireless communication, the set of instructions comprising one or more instructions that, when executed by one or more processors of a device, cause the device to perform the method of one or more of Aspects 1-60.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a transmitter user equipment (UE), comprising:
transmitting sidelink information associated with the transmitter UE, the sidelink information including information associated with sidelink communication of the transmitter UE in an unlicensed spectrum; and
receiving an indication indicating a set of multi-consecutive slot transmission (MCSt) parameters to be used in association with transmitting a set of MCSt transmissions for reception by a receiver UE in the unlicensed spectrum.

2. The method of claim 1, further comprising transmitting at least one MCSt transmission on sidelink for reception by the receiver UE based at least in part on the set of MCSt parameters.

3. The method of claim 1, wherein the sidelink information includes information associated with support of the transmitter UE for MCSt transmissions.

4. The method of claim 3, wherein the information associated with support of the transmitter UE for MCSt transmissions includes at least one of an indication that the transmitter UE supports MCSt transmissions or an indication of a maximum number of transport blocks supported by the transmitter UE in association with MCSt transmissions.

5. The method of claim 1, wherein the sidelink information includes information associated with support of the receiver UE for MCSt transmissions.

6. The method of claim 5, further comprising receiving the information associated with support of the receiver UE for MCSt transmissions from the receiver UE.

7. The method of claim 1, wherein the indication includes a sidelink unlicensed configuration or reconfiguration message received via radio resource control (RRC) signaling, the sidelink unlicensed configuration or reconfiguration message including an MCSt configuration indicating the set of MCSt parameters or information associated with reconfiguring the set of MCSt parameters.

8. The method of claim 7, wherein the set of MCSt parameters includes at least one of a quantity of slots in a set of slots associated with transmitting a set of transport blocks (TB)s, a quantity of TBs in the set of TBs, or a subchannel allocation associated with transmitting MCSt transmissions.

9. The method of claim 1, wherein the indication includes an activation message received via a medium access control (MAC) control element (CE), the activation message including information associated with activating the set of MCSt parameters.

10. The method of claim 9, further comprising transmitting the activation message for reception by the receiver UE via a MAC CE on sidelink.

11. The method of claim 1, wherein the sidelink information includes an indication of a preferred value for an MCSt parameter.

12. The method of claim 11, further comprising determining the preferred value for the MCSt parameter based at least in part on at least one of:
a quality of service (QoS) associated with a sidelink buffer status report (SL BSR), a channel condition associated with a sidelink between the transmitter UE and the receiver UE, or a listen-before-talk (LBT) performance characteristic associated with the transmitter UE.

13. The method of claim 1, wherein the indication includes a dynamic grant received in downlink control information (DCI), the dynamic grant indicating the set of MCSt parameters.

14. The method of claim 1, wherein the set of MCSt parameters indicates a first set of consecutive slots for initial transmissions of a set of transport blocks (TBs), wherein the first set of consecutive slots is indicated by a first slot in the set of slots, the first slot being indicated by a time gap associated with the first slot and a lowest index of a subchannel allocation associated with the first set of consecutive slots.

15. The method of claim 14, wherein the set of MCSt parameters includes at least one of:
an indication of a second set of consecutive slots for first retransmissions associated with the set of TBs,
an indication of a third set of consecutive slots for second retransmissions associated with the set of TBs,
a set of resources associated with indicating acknowledgment of the initial transmissions, or
or a set of resources associated with indicating acknowledgment of the first retransmissions.

16. The method of claim 1, wherein the set of MCSt parameters includes a set of resources to be used associated with transmitting acknowledgment information associated with a set of transport blocks (TBs), wherein the set of resources comprises a set of uplink control information (UCI) resources in a physical uplink shared channel (PUSCH).

17. The method of claim 1, wherein the set of MCSt parameters includes at least one of:
a hybrid automatic repeat request (HARQ) process number associated with one or more transport blocks (TBs) of a set of TBs,
an indication of a subchannel allocation configuration for the set of TBs,
an indication of a quantity of slots in a set of consecutive slots, or
an indication of a quantity of TBs.

18. The method of claim 1, further comprising performing a listen-before-talk (LBT) procedure at a plurality of LBT occasions based at least in part on the set of MCSt parameters, the plurality of LBT occasions being associated with a transmission of each transport block (TB) of a set of TBs.

19-21. (canceled)

22. A method of wireless communication performed by a network node, comprising: receiving sidelink information associated with a transmitter user equipment (UE), the sidelink information including information associated with sidelink communication of the transmitter UE in an unlicensed spectrum;
determining a set of multi-consecutive slot transmission (MCSt) parameters to be used by the transmitter UE in association with transmitting a set of MCSt transmissions for reception by a receiver UE in the unlicensed spectrum; and
transmitting an indication indicating the set of MCSt parameters for reception by the transmitter UE.

23-28. (canceled)

29. A transmitter user equipment (UE) for wireless communication, comprising:
one or more memories; and
one or more processors, coupled to the one or more memories, configured to:
transmit sidelink information associated with the transmitter UE, the sidelink information including information associated with sidelink communication of the transmitter UE in an unlicensed spectrum; and
receive an indication indicating a set of multi-consecutive slot transmission (MCSt) parameters to be used in association with transmitting a set of MCSt transmissions for reception by a receiver UE in the unlicensed spectrum.

30. (canceled)
